(19) United States
(12) Patent Application Publication
(10) Pub. No.: US 2026/0237727 A1
(43) Pub. Date: Aug. 13, 2026

(54) HERMETICALLY SEALED POLYMERIZED STRUCTURAL BATTERIES FOR WEARABLE DEVICES

(71) Applicant: Meta Platforms Technologies, LLC, Menlo Park, CA (US)

(72) Inventors: Steven Eickhoff, Redmond, WA (US); Mikael Wagner, Snohomish, WA (US); Charles Dominic Consorte, Dublin, CA (US); Mikhail Gordin, Bellevue, WA (US); Hongyang Li, Santa Clara, CA (US); Benjamin Cook, Woodinville, WA (US)

(21) Appl. No.: 19/534,665

(22) Filed: Feb. 9, 2026

Related U.S. Application Data
(60) Provisional application No. 63/756,718, filed on Feb. 10, 2025.

(51) Int. Cl. H01M 10/0525; H01M 10/0585

(52) U.S. Cl. CPC H01M 10/0525; H01M 10/0585

(57) ABSTRACT

A pair of smart glasses includes a temple arm, wherein a portion of the temple arm is coated in a hermetic coating. The pair of smart glasses includes a battery disposed within the temple arm such that an electrolyte of the battery is in contact with the hermetic coating of the temple arm. The electrolyte is polymerized so that the electrolyte is bonded to the hermetic coating of the temple arm.

### CROSS-REFERENCE TO RELATED APPLICATIONS

This application claims priority to U.S. Provisional Application No. 63/756,718, titled "Systems and Methods for Creating Structural Batteries," filed February 10, 2025, which is hereby incorporated by reference in its entirety.

### TECHNICAL FIELD

The present disclosure relates to batteries for wearable electronic devices, and more particularly to batteries having flexible polymer electrolytes and hermetic coatings for integration into temple arms of smart glasses.

### BACKGROUND

Wearable electronic devices, such as smart glasses, augmented reality glasses, and similar head-mounted devices incorporate various electronic components including processors, sensors, displays, speakers, and wireless communication modules, all of which require electrical power. Traditionally, these devices receive power from external sources, or batteries that are integrated within the temple arms of the eyewear.

Due to the moisture sensitivity of lithium-ion cells, conventional batteries for wearable consumer electronic devices require hermetic packaging, typically aluminum or polymer-laminate pouch packaging or welded steel can packaging. However, aluminum or polymer-laminate pouch packaging adds volume to cells due to packaging inefficiencies such as edge folds, which can limit the total battery energy that can be incorporated into a device or increase the overall size of the device. Steel can packaging, while providing robust moisture protection, adds weight that can decrease user comfort for wearable devices.

Wearable devices present additional form factor challenges for battery integration. Conventional lithium-ion batteries are manufactured in cuboidal or prismatic shapes that do not efficiently occupy curved device housings, such as the temple arms of eyewear, resulting in wasted volume within the device and limiting the total battery energy that can be integrated into the temple arm. Additionally, the rigid construction of conventional lithium-ion batteries makes them susceptible to performance degradation from electrode cracking and delamination when subjected to mechanical flexure (e.g., flexure during donning or doffing of the wearable devices). These limitations restrict battery placement to rigid, protected sections of a device and reduce the overall flexibility of the wearable device design, which can decrease user comfort.

Smart glasses and similar wearable devices may be configured with removable temple arms to allow for battery replacement or servicing. However, removability requirements can constrain battery design and reduce available energy storage capacity. Conventional batteries designed for removable configurations must be sufficiently robust to withstand handling during replacement, necessitating additional packaging such as thicker aluminum or polymer-laminate pouch packaging that further reduces the volume available for energy storage.

As such, there is a need to address one or more of the above-identified challenges. A brief summary of solutions to the issues noted above are described below.

### SUMMARY

The present disclosure provides structural batteries that integrate directly into wearable device housings, such as temple arms of smart glasses, by utilizing polymer electrolytes that bond to hermetic coatings applied to interior surfaces of the housing. For example, the polymer electrolyte may be polymerized after injection into an electrode stack disposed within the housing, causing the electrolyte to bond to the hermetic coating and to electrode layers of the electrode stack. This configuration enables the battery to serve as a structural component of the wearable device while providing energy storage functionality, and the hermetic coating applied directly to the housing interior may provide moisture protection and reduce or eliminate the need for separate aluminum or polymer-laminate pouch packaging or steel can packaging. Additionally, the structural batteries described herein may incorporate terraced electrode stacks having layers of varying dimensions that conform to curved or non-rectilinear geometries of wearable device housings. The terraced configuration may enable the battery to occupy space within curved sections of temple arms that would otherwise be unused by conventional prismatic batteries, thereby increasing the total battery energy that can be integrated into the wearable device. Moreover, the structural batteries may be flexible, enabling the battery to withstand cyclic deformation without degradation of battery performance. The flexibility may enable the battery to be disposed in regions of the wearable device that experience repeated mechanical flexure during use, such as during donning and doffing of smart glasses. A flexible layer within the hermetic coating structure may enable the hermetic coating to tolerate cyclic deformation while maintaining moisture barrier properties. The polymer electrolyte may have a tunable elastic modulus that enables adjustment of mechanical properties based on application requirements. The structural battery architecture may also accommodate removable temple arm configurations by providing mechanical, thermal, and electrical connections between removable sections of the temple arm.

In some embodiments, a pair of smart glasses is provided. The smart glasses include a temple arm, wherein a portion of the temple arm is coated in a hermetic coating. The pair of smart glasses includes a battery disposed within the temple arm such that an electrolyte of the battery is in contact with the hermetic coating of the temple arm. The electrolyte is polymerized so that the electrolyte is bonded to the hermetic coating of the temple arm.

In some embodiments, the smart glasses may include one or more of the following features. The battery may be mechanically coupled to the temple arm such that mechanical forces applied to the temple arm are at least partially supported by the battery. The battery may be configured to withstand cyclic deformation without degradation of battery performance. The battery may include an electrode stack having a terraced configuration, wherein a first layer of the electrode stack has a different geometry than a second layer of the electrode stack. The electrode stack may be a non-cuboidal shape. The electrode stack may conform to a curved geometry of the temple arm. The portion of the temple arm may further include a substrate layer disposed between the temple arm and a flexible layer. The flexible layer may be disposed on the substrate layer, wherein the flexible layer is configured to enable the hermetic coating to tolerate cyclic deformation. The hermetic coating may be disposed on the flexible layer, wherein the hermetic coating forms a seal around the battery that prevents moisture ingress into the battery. A protective layer may be disposed on the hermetic layer, wherein the protective layer is configured to at least partially seal the hermetic coating from environmental exposure. The smart glasses may further include an inner cover disposed within the temple arm and coupled to the battery. The inner cover may be coated in the hermetic coating. Polymerization of the electrolyte may cause the electrolyte to be bonded to the hermetic coating of the inner cover. The smart glasses may further include an electrical component and an outer cover configured to at least partially seal the temple arm. The outer cover may enclose an electrical component and the inner cover within the temple arm. The temple arm may include a front portion of the temple arm, a rear portion of the temple arm, and a connector configured to removably couple the front portion of the temple arm and the rear portion of the temple arm. The smart glasses may further include a lens frame and a hinge coupled to the lens frame and the front portion of the temple arm. The smart glasses may further include a lens frame and a hinge including a first hinge component and a second hinge component. The first hinge component may be coupled to the lens frame, wherein the first hinge component includes a first connector. The second hinge component may be coupled to the temple arm, wherein the second hinge component includes a second connector configured to removably couple to the first connector of the first hinge component. The battery may have a flexural rigidity between 2 Nm² and 10 Nm². The battery may be configured to maintain at least 80% capacity retention after 11,000 bend cycles. The electrolyte may include a polymer electrolyte having a tunable elastic modulus.

In some embodiments, a structural battery for a wearable device is provided. The structural battery includes an electrode stack comprising a plurality of anode layers and a plurality of cathode layers arranged in an alternating configuration. The structural battery includes a polymer electrolyte disposed between the plurality of anode layers and the plurality of cathode layers. The polymer electrolyte provides mechanical support to the electrode stack. The structural battery includes a hermetic coating disposed around the electrode stack and the polymer electrolyte. The polymer electrolyte is bonded to the hermetic coating.

In some embodiments, the structural battery may include one or more of the following features. The electrode stack may have a terraced configuration in which the plurality of anode layers and the plurality of cathode layers have varying dimensions to form a non-cuboidal shape. The hermetic coating may include a hermetic layer encapsulating the electrode stack to prevent moisture ingress into the electrode stack and the polymer electrolyte. The hermetic coating may include a flexible layer disposed on a first side of the hermetic layer to support the hermetic coating during cyclic deformation. The hermetic coating may include a protective layer disposed on a second side of the hermetic layer, opposite the first side, that at least partially seals the hermetic layer from environmental exposure. The polymer electrolyte may have a tunable elastic modulus configured to provide a selected flexural rigidity for the structural battery. The hermetic coating may include a port configured to enable injection of the polymer electrolyte into the electrode stack, wherein the port is sealed after injection of the polymer electrolyte. The structural battery may have a flexural rigidity between 2 Nm² and 10 Nm². The battery may be configured to maintain at least 80% capacity retention after 11,000 bend cycles.

In some embodiments, a method of manufacturing a wearable device with an integrated structural battery is provided. The method includes applying a hermetic coating to an interior surface of a housing of the wearable device. The method includes applying the hermetic coating to an interior surface of an inner cover of the wearable device. The method includes disposing an electrode stack within the housing such that the electrode stack is adjacent to the hermetic coating of the housing. The method includes sealing the electrode stack within the housing with the inner cover such that the electrode stack is adjacent to the hermetic coating of the inner cover. The method includes injecting a polymer electrolyte into the housing such that the polymer electrolyte contacts the hermetic coating and fills spaces between electrode layers of the electrode stack. The method includes curing the polymer electrolyte to bond the polymer electrolyte to the hermetic coating and to the electrode layers of the electrode stack.

In some embodiments, the method may include one or more of the following features. The method may further include disposing an electrical component over the inner cover. The method may further include sealing the housing with an outer cover, wherein the outer cover encloses the electrical component, the inner cover, and the electrode stack within the housing. The method may further include overmolding the housing with a thermoplastic such that the housing is encapsulated by the thermoplastic.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A illustrates an example temple arm incorporating a structural battery, in accordance with some embodiments.

FIG. 1B illustrates an example pair of smart glasses with a temple arm incorporating a structural battery, in accordance with some embodiments.

FIG. 2 illustrates an example temple arm including one or more structural batteries extending along a length of the temple arm, in accordance with some embodiments.

FIG. 3 illustrates an example architecture of the structural battery, in accordance with some embodiments.

FIG. 4 illustrates an example terraced electrode stack, in accordance with some embodiments.

FIG. 5 illustrates an example hermetic coating structure, in accordance with some embodiments.

FIGS. 6A-6D illustrate an example method of assembling a temple arm housing a structural battery, in accordance with some embodiments.

FIGS. 7A-7D illustrate an example method of assembling a temple arm housing a structural battery and an electrical component, in accordance with some embodiments.

FIGS. 8A-8C illustrate a first example method of separately assembling a structural battery, in accordance with some embodiments.

FIGS. 9A-9C illustrate a second example method of separately assembling a structural battery, in accordance with some embodiments.

FIG. 10A illustrates an example removable temple arm assembly in a first configuration, in accordance with some embodiments.

FIG. 10B illustrates an example removable temple arm assembly in a second configuration with a modular design, in accordance with some embodiments.

FIG. 11 shows an example method flow chart for manufacturing a wearable device with a structural battery, in accordance with some embodiments.

FIGS. 12A, 12B, 12C-1 and 12C-2, illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Structural Battery

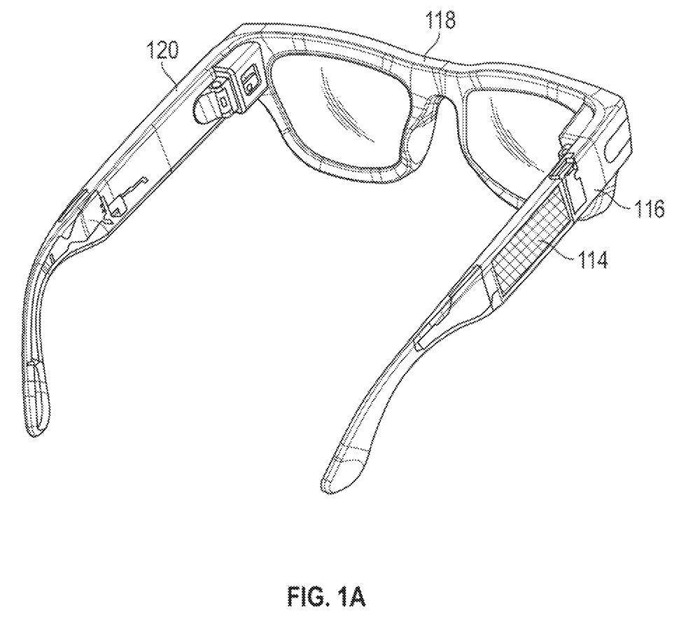

FIG. 1A illustrates an example pair of smart glasses with a temple arm incorporating a structural battery, in accordance with some embodiments. In the depicted example, a structural battery 114 is disposed within a temple arm 116 (e.g., temple arm 100, as shown in FIG. 1B) of a pair of smart glasses 118. The temple arm 116 may include the electrode stack 102, hermetic coating 104, outer layer 106, and terraced configuration described below with reference to FIG. 1B. The pair of smart glasses 118 may include a lens frame coupled to the temple arm 116. In some embodiments, the lens frame includes one or more lenses disposed within the lens frame. In some embodiments, at least one of the lenses includes a waveguide-based display configured to present an augmented-reality experience or a smart glasses experience to a user. The waveguide-based display may receive image data from a projector or other image source disposed within the temple arm 116 or the lens frame, and may direct light toward the user's eye to present virtual content superimposed on the user's view of the physical environment.

The pair of smart glasses 118 may include a second temple arm 120 coupled to the lens frame opposite the temple arm 116. In some embodiments, the structural battery 114 is disposed within the temple arm 116, while the second temple arm 120 does not include a structural battery. In some embodiments, both the temple arm 116 and the second temple arm 120 include respective structural batteries, which may increase the total energy storage capacity of the pair of smart glasses 118. The pair of smart glasses 118 may include hinges coupling the temple arm 116 and the second temple arm 120 to the lens frame. The hinges may enable the temple arms to pivot relative to the lens frame, allowing the pair of smart glasses 118 to be folded for storage or unfolded for wearing. In some embodiments, the pair of smart glasses 118 includes various electronic components powered by the structural battery 114, such as processors, sensors, displays, speakers, cameras, and wireless communication modules. The structural battery 114 may be electrically connected to components disposed within the lens frame, such as the waveguide-based display, sensors, or processors. The structural battery 114 may also be electrically connected to components disposed within the temple arm 116 or the second temple arm 120, such as speakers, microphones, or additional sensors. In some embodiments, electrical connections between the structural battery 114 and components in the lens frame are routed through the hinges coupling the temple arms to the lens frame. The structural battery 114 may provide energy storage for these electronic components while also contributing to the mechanical structure of the temple arm 116 or the second temple arm 120.

FIG. 1B illustrates an example temple arm incorporating a structural battery, in accordance with some embodiments. As shown in FIG. 1B, a temple arm 100 incorporates a structural battery that provides energy storage while contributing to the mechanical structure of the temple arm 100. The temple arm 100 includes an electrode stack 102 positioned within the temple arm structure. The electrode stack 102 comprises a plurality of anode layers and cathode layers arranged in a stacked configuration.

A hermetic coating 104 surrounds the electrode stack 102. The hermetic coating 104 provides moisture barrier properties that prevent water or moisture ingress into the electrode stack 102. The hermetic coating 104 may also provide environmental protection by preventing ingress of foreign objects or environmental contaminants into the electrode stack 102. The hermetic coating 104 may comprise materials such as metal oxides deposited via atomic layer deposition or other deposition techniques. A portion of the temple arm 100 is coated in the hermetic coating 104 such that a battery disposed within the temple arm 100 has one or more electrolytes in contact with (or bonded to) the hermetic coating 104 of the temple arm 100. The electrolyte may be polymerized so that the electrolyte is bonded to the hermetic coating 104 of the temple arm 100.

An outer layer 106 encases the hermetic coating 104 and provides cosmetic and structural support for the temple arm 100. The outer layer 106 forms an external surface of the temple arm 100 and may comprise materials suitable for eyewear applications. In some embodiments, the outer layer 106 comprises thermoplastic materials such as nylon-based materials, polypropylene, polycarbonate, PET, or polyamide materials. The outer layer 106 may be applied via various manufacturing processes, including low pressure molding, compression molding, thermoforming, or outside of mold lamination. In some embodiments, the outer layer 106 is overmolded onto the hermetic coating 104 such that the hermetic coating 104 and the battery are encapsulated by the outer layer 106.

In some embodiments, the electrode stack 102 is configured with a terraced configuration. For example, as shown in FIG. 1B, the electrode stack 102 includes a terrace 108 and a terrace 110, which represent portions of the electrode stack 102 having different dimensions to form a non-uniform stack design. In the terraced configuration, a first layer of the electrode stack 102 has a different geometry than a second layer of the electrode stack 102. The terraced configuration allows the electrode stack 102 to conform to a three-dimensional shape of the temple arm 100 and utilize space that would otherwise be unutilized or underutilized by conventional prismatic batteries. The electrode stack 102 may be a non-cuboidal shape, and the electrode stack 102 may conform to a curved geometry of the temple arm 100.

The temple arm 100 may include a curved portion 112 that extends from a main body of the temple arm 100. In some embodiments, the structural battery is disposed within the curved portion 112. The electrode stack 102 may be placed into the curved portion 112 (or into a curved mold) prior to curing of a polymer electrolyte to form a curved shape. The curved portion 112 may enable the temple arm 100 to be contoured for comfortable fit around a user's head while maintaining battery functionality throughout the curved section. By conforming to the curved geometry, the structural battery may occupy space within the curved portion 112 that would be unutilized by conventional rectilinear batteries, thereby increasing the total battery energy that can be integrated into the temple arm 100.

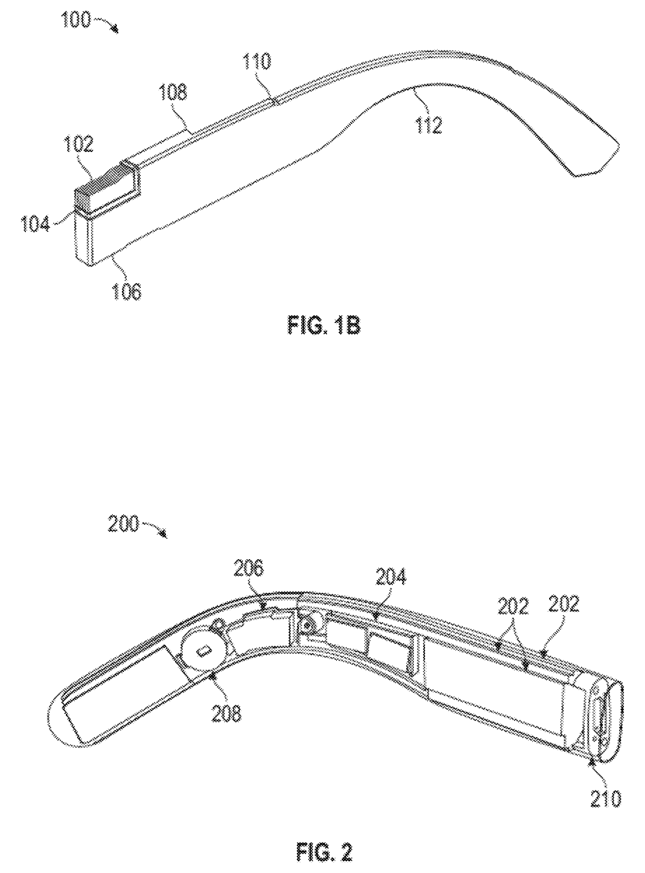

FIG. 2 illustrates an example temple arm including one or more structural batteries extending along a length of the temple arm, in accordance with some embodiments. As shown in FIG. 2, the temple arm 200 includes a terraced electrode stack 202 positioned along a portion of the temple arm 200. The terraced electrode stack 202 comprises multiple layers of varying dimensions that conform to a curved shape of the temple arm 200. For example, as shown in FIG. 2, the temple arm 200 includes a curvature on an inner surface of the temple arm 200, where the inner surface is a surface closest to a user when the smart glasses are worn. The terraced electrode stack 202 is terraced in a direction corresponding to this curvature, with electrode layers decreasing in dimension toward the inner surface. In this configuration, a battery portion closest to the user is smaller than a battery portion farthest from the user, allowing the terraced electrode stack 202 to conform to the curved inner surface of the temple arm 200. This terracing arrangement enables the structural battery to occupy the curved volume within the temple arm 200 while maintaining a comfortable fit against the user's head.

The terraced electrode stack 202 may extend along an entire length of the temple arm 200, including a temple tip region of the temple arm 200. The temple arm 200 (including the main body and the temple tip region) may undergo cyclic mechanical loading during use, such as during donning and doffing of the smart glasses. The battery may be mechanically coupled to the temple arm 200 such that mechanical forces applied to the temple arm 200 are at least partially supported by the battery. The battery may be configured to withstand cyclic deformation without degradation of battery performance, enabling the battery to be disposed in regions of the temple arm 200 that experience repeated flexure.

The structural battery may also provide structural rigidity to the temple arm 200. The polymer electrolyte disposed within the terraced electrode stack 202 may bond to electrode layers and to the hermetic coating, creating a mechanically integrated structure that contributes to the overall stiffness of the temple arm 200. In this way, the structural battery may bear a portion of mechanical loads applied to the temple arm 200, reducing the load-bearing requirements on the temple arm frame or chassis. As a result, less material may be needed for the chassis or frame of the temple arm 200, which may enable a thinner housing wall thickness while maintaining adequate structural integrity. The reduced material requirements for the temple arm frame may free up volume within the temple arm 200 that may be used for additional battery capacity, thereby increasing the total energy storage of the smart glasses. Alternatively, the freed volume may be used to accommodate other electrical components within the temple arm 200, such as additional sensors, processors, or communication modules. In some embodiments, the combination of structural support from the battery and reduced frame material may enable both increased battery capacity and integration of additional electrical components within the same temple arm volume.

With continued reference to FIG. 2, electrical components 206 are disposed within the temple arm 200 adjacent to the terraced electrode stack 202. In some embodiments, the electrical components 206 include a button 208 (e.g., for controlling functions of the smart glasses). A speaker 204 is positioned proximate to the electrical components 206. The speaker 204 may be configured to provide audio output to a user wearing the smart glasses. The structural battery may include cutouts for the speaker 204 and the electrical components 206 within the temple arm 200, allowing the terraced electrode stack 202 to be integrated alongside other functional elements while conforming to the curved geometry of the temple arm 200.

The cutouts to accommodate the speaker 204 and/or the electrical components 206 may be formed by the terraced configuration of the terraced electrode stack 202, where electrode layers are dimensioned to accommodate the speaker 204 or the electrical components 206. For example, electrode layers in a region adjacent to the speaker 204 may have reduced dimensions compared to electrode layers in other regions of the terraced electrode stack 202, creating a recessed area that provides clearance for the speaker 204. Similarly, the terraced configuration may include electrode layers with varying widths or lengths that define spaces for the electrical components 206 within the temple arm 200. In this manner, the terraced electrode stack 202 may be shaped to integrate with other components of the temple arm 200 without requiring separate cutout operations after electrode stack fabrication.

In some embodiments, a connector 210 is disposed at an end of the temple arm 200 proximate to a lens frame. The connector 210 facilitates electrical and mechanical connections for charging the battery, transferring data, or connecting the temple arm 200 to other components of the smart glasses. The connector 210 may comprise a pogo pin connector having spring-loaded pins that establish electrical contact when the temple arm 200 is connected to the lens frame or to an external charging device. The spring-loaded pins may be configured to maintain contact pressure across a range of mechanical tolerances, enabling reliable electrical connections during repeated connection and disconnection cycles. Alternatively, the connector 210 may comprise a magnetic connector that uses magnetic attraction to align and secure the connection between the temple arm 200 and other components. The magnetic connector may include alignment features that guide the temple arm 200 into a correct orientation during connection, and the magnetic attraction may provide a tactile indication to a user when the connector 210 is properly seated. In some embodiments, the connector 210 comprises a combination of pogo pins and magnetic elements, where the magnetic elements provide alignment and retention while the pogo pins provide electrical contact. The connector 210 may provide multiple electrical pathways for different functions, including power connections for charging the battery disposed within the temple arm 200 and data connections for communication between processors, sensors, or other electrical components disposed within the temple arm 200 and components disposed within the lens frame. The data connections may support various communication protocols, including serial communication protocols, I2C, SPI, or proprietary protocols designed for wearable device applications. The connector 210 may also provide mechanical coupling between the temple arm 200 and other components of the smart glasses through latching features that secure the temple arm 200 to the lens frame when the smart glasses are assembled. The latching features may comprise snap-fit elements, detent mechanisms, or threaded fasteners, and may be configured to allow repeated connection and disconnection of the temple arm 200 for battery replacement or servicing. In some embodiments, the connector 210 includes alignment features such as keying elements that prevent incorrect orientation of the temple arm 200 during connection.

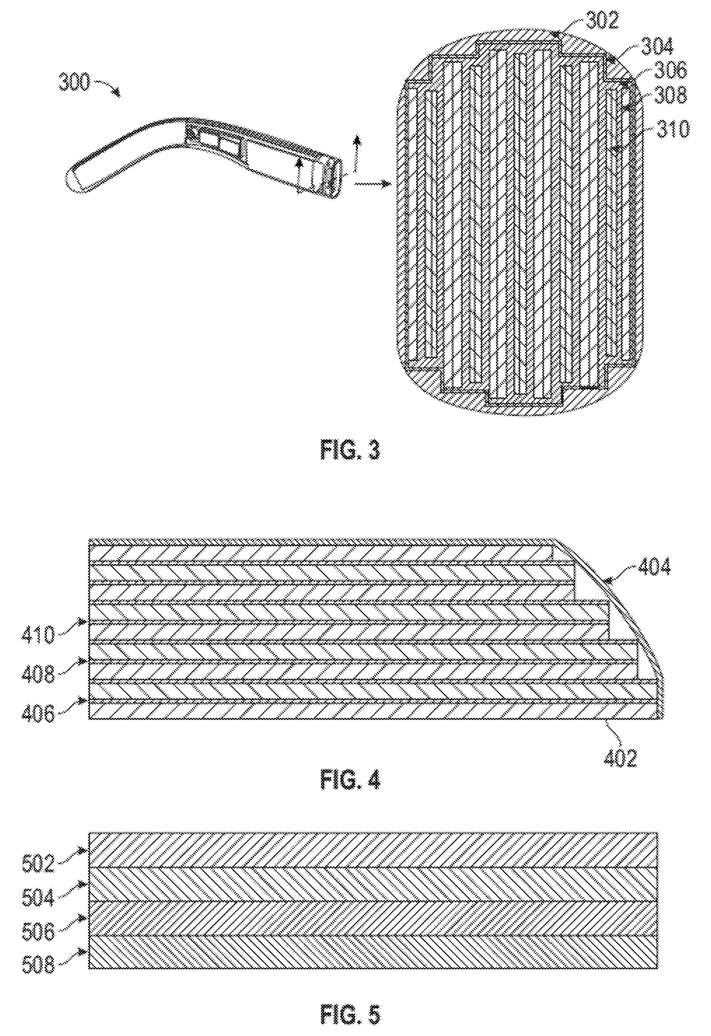

FIG. 3 illustrates an example architecture of the structural battery, in accordance with some embodiments. In some embodiments, as shown in FIG. 3, disposed within the temple arm 300 is a structural battery that includes multiple layers, including an outer layer 302, a hermetic coating 304, structural electrolyte 306 (e.g., polymer electrolyte), anode layers 308, and cathode layers 310.

For example, an outer layer 302 is positioned at an outermost portion of the temple arm 300. The outer layer 302 provides an external surface of the temple arm 300 and may comprise materials suitable for eyewear applications. Beneath the outer layer 302 is a hermetic coating 304. The hermetic coating 304 serves as a moisture barrier to protect battery components from environmental exposure. The hermetic coating 304 lines an interior cavity that houses the battery and may comprise materials such as metal oxides deposited via atomic layer deposition or other deposition techniques.

With continued reference to FIG. 3, multiple anode layers 308 and cathode layers 310 are arranged in an alternating stacked configuration. A structural electrolyte 306 is disposed between adjacent electrode layers and fills spaces between the anode layers 308 and the cathode layers 310 within a hermetically sealed region. As shown in FIG. 3, the anode layers 308 and the cathode layers 310 extend vertically through the battery structure, with the structural electrolyte 306 positioned between adjacent electrode layers. It should be appreciated that the anode layers 308 and the cathode layers 310 may be oriented in various directions relative to the temple arm 300, including horizontally, vertically, perpendicular to a longitudinal axis of the temple arm 300, parallel to the longitudinal axis, or at an oblique angle, with the structural electrolyte 306 accommodating various electrode layer orientations while maintaining mechanical support and ionic conductivity. The structural electrolyte 306 may be injected in a liquid state and cured to a solid state, thereby bonding the structural electrolyte 306 to the anode layers 308, the cathode layers 310, and the hermetic coating 304. In some embodiments, the anode layers 308 comprise graphite anodes and the cathode layers 310 comprise lithium cobalt oxide cathodes. The structural electrolyte 306 is a polymer electrolyte that provides both ionic conductivity for battery operation and mechanical support to an electrode stack. The structural electrolyte 306 may be bonded to the hermetic coating 304 through polymerization.

In some embodiments, the polymer electrolyte may have a tunable elastic modulus (e.g., by tuning the polymer chemistry), allowing mechanical properties of the structural battery to be adjusted based on application requirements. In some embodiments, the polymer electrolyte may have a tensile modulus in a range of approximately 1 kPa to 5 kPa.

In some embodiments, the polymer electrolyte may have a tunable flexural rigidity, with the polymer electrolyte configured to provide a flexural rigidity in a range of approximately 2 Nm² to 10 Nm². The polymer electrolyte may have an elastic recovery of 98%. The tunable stiffness of the polymer electrolyte enables the structural battery to serve as a structural component of the device, thereby lowering requirements on packaging rigidity. The polymer electrolyte may be robust to cyclic deformation, such as during donning and doffing of the wearable device, thereby further decreasing required packaging rigidity while also enabling improved fit and comfort.

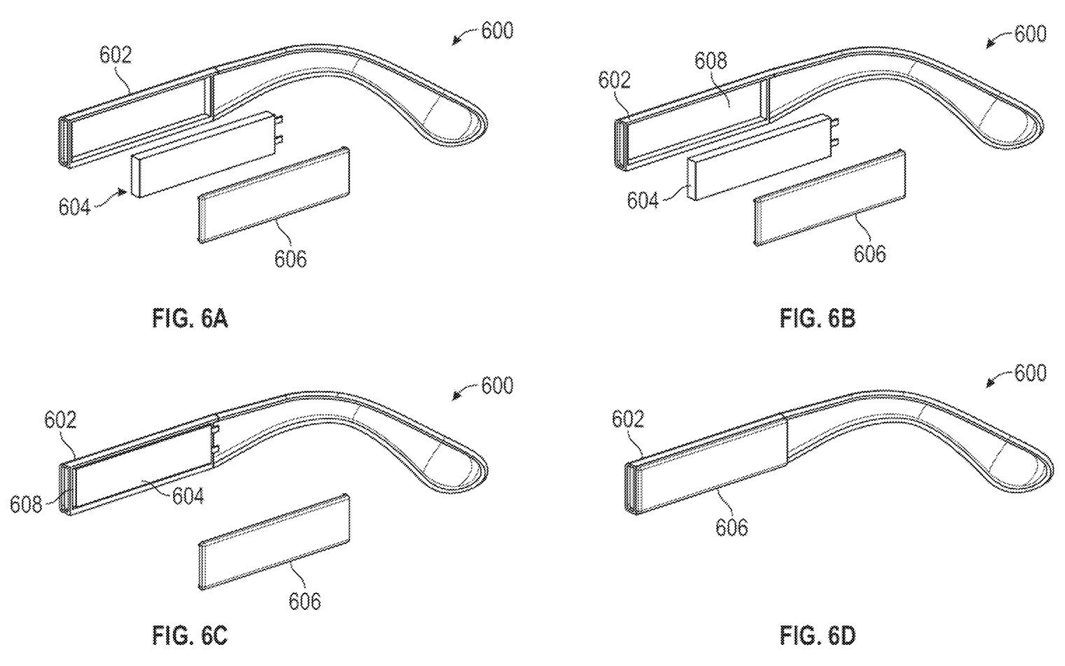

FIG. 4 illustrates an example terraced electrode stack, in accordance with some embodiments. In some embodiments, the terraced electrode stack 402 comprises multiple alternating layers of electrode materials arranged in a stepped configuration to form a non-cuboidal shape. As shown in FIG. 4, a first anode-electrolyte-cathode layer 406 has a first length, a second anode-electrolyte-cathode layer 408 has a second length shorter than the first length, and a third anode-electrolyte-cathode layer 410 has a third length shorter than the second length. The varying layer lengths, with each successive layer extending further than the layer above it, create a terraced or staircase-like profile that enables the terraced electrode stack 402 to fill rounded or curved regions of the temple arms.

As shown in FIG. 4, the outer layer 404 is curved and wraps around the terraced electrode stack 402, following the contour of the stepped electrode layers. The curved configuration of the outer layer 404 enables the battery assembly to conform to curved geometries of device housings, such as the temple arms of smart glasses. The terraced electrode stack 402 minimizes unused space within the region encapsulated by the outer layer 404 by filling volume that would otherwise remain empty if a conventional rectilinear electrode stack were used. The stepped profile of the terraced electrode stack 402 allows electrode material to occupy regions near the curved boundary of the outer layer 404 that a uniform rectangular stack would not reach. In this manner, the terraced configuration may increase the volumetric energy density of the battery assembly by reducing unused volume within the encapsulated region.

In some embodiments, the terraced electrode stack 402 may comprise various electrode chemistry options. In some embodiments, the terraced electrode stack 402 comprises a blended silicon anode with a 10% SiOx/Gr composition or a pure silicon anode. In some embodiments, the terraced electrode stack 402 comprises a crystallographically oriented LCO cathode produced by electrodeposition.

Assembly of the terraced electrode stack 402 may be performed using various techniques to maintain alignment and alignment of the electrode layers. In some embodiments, the terraced electrode stack 402 uses a pick-and-place tool with a vision system for electrode stacking in conjunction with pressure sensitive adhesive (PSA) or UV cure adhesive to maintain alignment. The vision system enables precise placement of electrode layers having non-rectilinear footprints that vary as a function of stack height. In some embodiments, the terraced electrode stack 402 uses 3D shaped molds and edge alignment to maintain alignment during assembly. The 3D shaped molds may be segmented to accommodate the varying layer dimensions of the terraced configuration. The terraced electrode stack 402 may have an alignment precision of +/-0.2 mm.

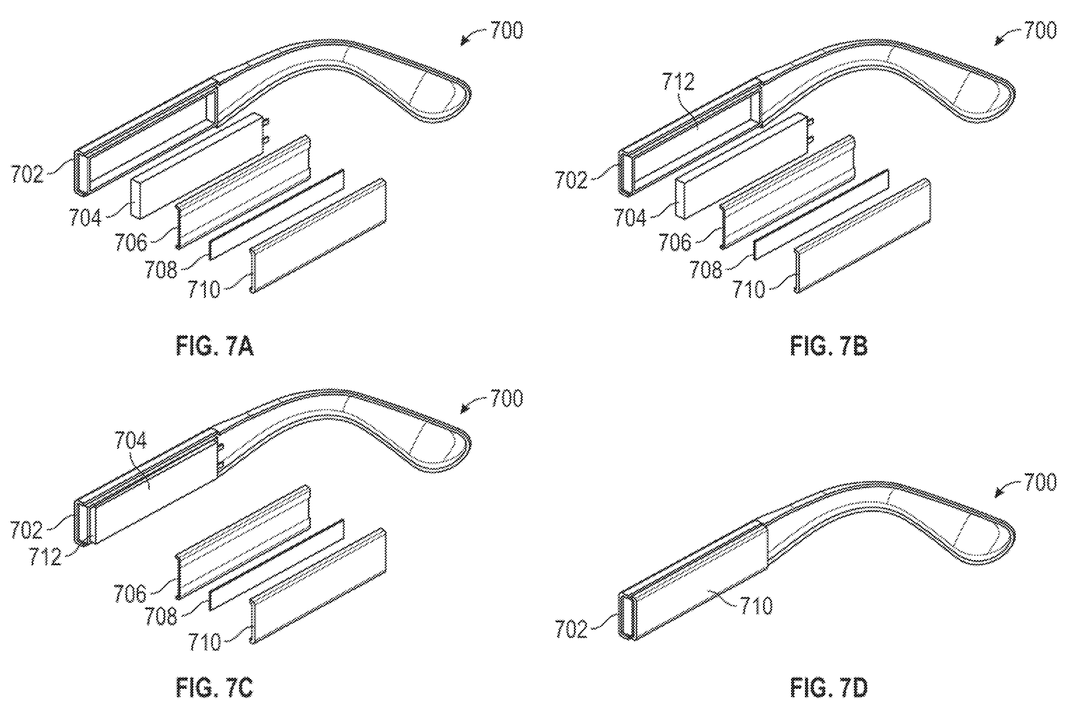

FIG. 5 illustrates an example hermetic coating structure, in accordance with some embodiments. In some embodiments, the hermetic coating structure comprises multiple layers arranged in a stacked configuration, including a protective layer 502, a hermetic layer 504, a flexible layer 506, and a substrate 508.

A substrate 508 is shown at a bottom of the stack (e.g., the hermetic coating structure). The substrate 508 provides a suitable surface onto which other layers of the hermetic coating structure may be applied. The substrate 508 may be disposed between the temple arm and the flexible layer 506. In some embodiments, the substrate 508 is applied via spray coating. In some embodiments, the substrate 508 is applied via dip coating. In some embodiments, the substrate 508 is applied via chemical vapor deposition. In some embodiments, the substrate 508 comprises a heat shrink material that is physically applied as an outer shell.

A flexible layer 506 is disposed on the substrate 508. In some embodiments, the flexible layer 506 supports the hermetic layer 504 during cyclic deformation. For example, the flexible layer 506 enables the hermetic coating structure to accommodate mechanical deformation, such as bending or flexing, without compromising integrity of the hermetic seal. In some embodiments, the flexible layer 506 comprises CVD-deposited parylene or an organic polymer substrate such as PP, PET, or PFA.

A hermetic layer 504 is disposed on the flexible layer 506. In some embodiments, the hermetic layer 504 serves as a moisture barrier to prevent water vapor transmission into battery components. The hermetic layer 504 encapsulates the electrode stack to prevent moisture ingress into the electrode stack and a polymer electrolyte. In some embodiments, the hermetic layer 504 comprises ALD-deposited Al2O3. In some embodiments, the hermetic layer 504 comprises other metal oxides deposited via atomic layer deposition. In some embodiments, the hermetic layer 504 comprises multi-layer inorganic coatings such as Al2O3/TiO2, Al2O3/SiO2, or Al2O3/ZnO. In some embodiments, the hermetic layer 504 is produced by plasma-enhanced chemical vapor deposition (PECVD). In some embodiments, the hermetic layer 504 comprises SiNx deposited by PECVD.

The hermetic coating structure includes a protective layer 502 disposed at a top of the stack, above the hermetic layer 504. The protective layer 502 provides an outer barrier that shields underlying layers from physical damage and environmental exposure. The protective layer 502 is configured to at least partially seal the hermetic coating from environmental exposure. In some embodiments, the protective layer 502 comprises sputter-coated aluminum and/or polypropylene.

The hermetic coating structure may include additional layers to promote adhesion between organic and inorganic layers and provide corrosion resistance. In some embodiments, the hermetic coating structure includes additional layers such as TiAlO, BN, or AlBNO disposed between the flexible layer 506 and the hermetic layer 504. In some embodiments, the hermetic coating structure includes a Ta-C (polycrystalline diamond) layer. The Ta-C layer may survive greater than 700,000 cycles at 2% strain, enabling the hermetic coating structure to withstand cyclic mechanical loading experienced during use of wearable devices.

The hermetic coating structure provides moisture barrier properties characterized by water vapor transmission rate (WVTR) specifications. For example, the hermetic coating forms a seal around the battery that prevents moisture ingress into the battery. At a coupon level, where a coupon is a small sample or test specimen of the hermetic coating material, the hermetic coating may have a WVTR of less than 10⁻³ g/m²/day at 38°C and 90% relative humidity. The coupon-level WVTR specification may be a test of the hermetic coating material coupon subject to bend cycling. At a cell level, the hermetic coating may have a WVTR of less than 10⁻⁶ atm*cc/s at 38°C and 90% relative humidity. The cell-level WVTR specification may be subject to accelerated aging and bend cycling.

The portion of the temple arm may comprise the substrate 508 disposed between the temple arm and the flexible layer 506, the flexible layer 506 disposed on the substrate 508, the hermetic coating disposed on the flexible layer 506, and the protective layer 502 disposed on the hermetic layer 504. A structural battery for a wearable device may comprise a hermetic coating that includes the hermetic layer 504 encapsulating the electrode stack to prevent moisture ingress into the electrode stack and the polymer electrolyte, the flexible layer 506 disposed on a first side of the hermetic layer 504 to support the hermetic coating during cyclic deformation, and the protective layer 502 disposed on a second side of the hermetic layer 504, opposite the first side, that at least partially seals the hermetic layer 504 from environmental exposure.

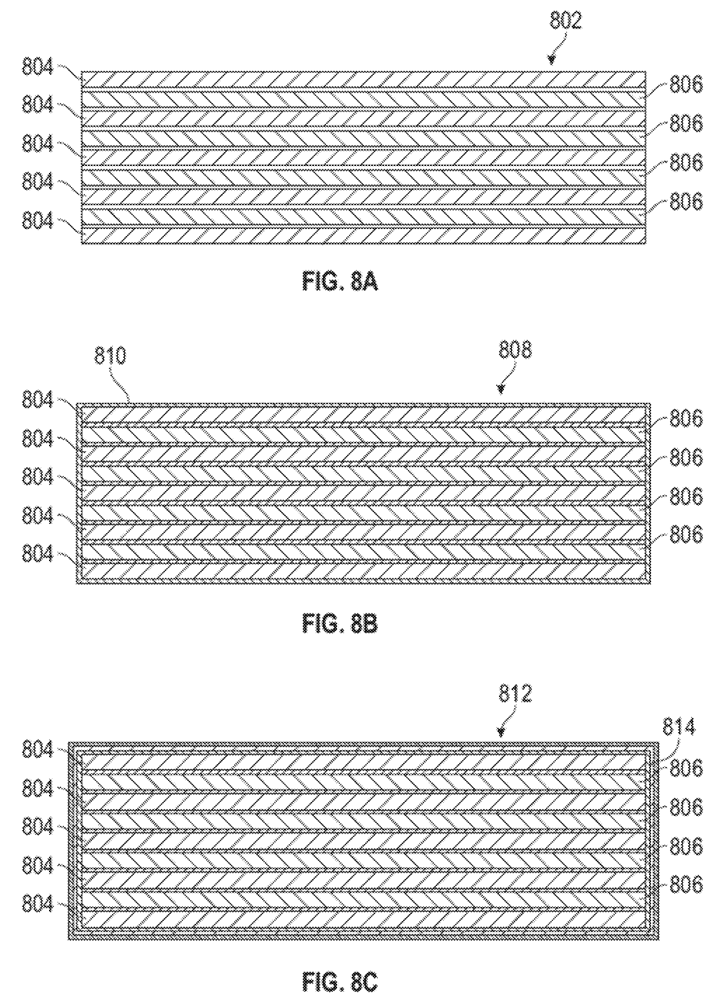

FIGS. 6A-6D illustrate an example method of assembling a temple arm housing with a structural battery, in accordance with some embodiments.

Referring to FIG. 6A, in some embodiments, the temple arm frame 602 is configured to receive the electrode stack 604 within a channel or cavity formed along a length of the temple arm frame 602. The temple arm frame 602 is configured to couple to the cover 606 to encapsulate the electrode stack 604 within the temple arm 600. When the cover 606 is attached to the temple arm frame 602, the electrode stack 604 is enclosed within a sealed compartment formed by the temple arm frame 602 and the cover 606.

The temple arm frame 602 may have an elongated shape with a curved portion that follows a contour typical of eyewear temple arms. While not shown, it should be appreciated that, in some embodiments, the electrode stack 604 (e.g., a terraced electrode stack) may be configured to be disposed within the curved portion of the temple arm frame 602 with a corresponding cover.

In some embodiments, the temple arm 600 may include alignment features corresponding with alignment features of the electrode stack 604. For example, the temple arm 600 includes notches that engage with corresponding tabs of the electrode stack 604, thereby providing alignment and secure attachment prior to polymerization of the electrode stack 604.

The temple arm frame 602 may have a reduced enclosure thickness to maximize volume available for the electrode stack 604. In some embodiments, the temple arm frame 602 has a reduced thickness of 0.6 mm. The reduced thickness of 0.6 mm enables increased battery volume while maintaining structural integrity of the temple arm 600. In some embodiments, the temple arm frame 602 has a reduced thickness of 0.3 mm using composites and compression molding. The reduced thickness of 0.3 mm may be achieved using composite materials such as carbon fiber reinforced polymers processed via compression molding techniques. The thinner enclosure transfers more stress to the battery, and the structural battery may be configured to support mechanical loads applied to the temple arm 600.

Referring to FIG. 6B, the temple arm frame 602 and the cover 606 are shown with a hermetic coating 608 applied to interior surfaces. The hermetic coating 608 is applied to an interior surface of the temple arm frame 602 and the cover 606 prior to disposing the electrode stack 604 within the temple arm frame 602. The hermetic coating 608 provides a moisture barrier that protects the electrode stack 604 from environmental exposure when the temple arm 600 is assembled.

When the electrode stack 604 is disposed within the temple arm frame 602 (as shown in FIG. 6C) and sealed with the cover 606 (as shown in FIG. 6D), a polymer electrolyte may be injected into the assembly such that the polymer electrolyte contacts the hermetic coating 608 and fills spaces between electrode layers of the electrode stack 604. Curing of the polymer electrolyte bonds the polymer electrolyte to the hermetic coating 608 and to the electrode layers of the electrode stack 604. In this manner, the structural battery forms a portion of the mechanical structure of the temple arm 600. The bonding of the polymer electrolyte to both the hermetic coating 608 and the electrode layers creates a mechanically integrated assembly in which the structural battery contributes to the overall rigidity of the temple arm 600. The cured polymer electrolyte provides mechanical support to the electrode stack 604, and the bond between the polymer electrolyte and the hermetic coating 608 transfers mechanical loads between the structural battery and the temple arm frame 602. As a result, mechanical forces applied to the temple arm 600 may be at least partially supported by the structural battery, reducing the load-bearing requirements on the temple arm frame 602 alone. This load-sharing arrangement may enable the temple arm frame 602 to have a reduced wall thickness while maintaining adequate structural integrity for the temple arm 600.

The cover 606 may be attached to the temple arm frame 602 using various sealing techniques. In some embodiments, the cover 606 is heat sealed to the temple arm frame 602 using polypropylene or other thermoplastic materials that form a bond when heated. In some embodiments, the cover 606 is adhesively bonded to the temple arm frame 602 using pressure sensitive adhesive or UV cure adhesive. In some embodiments, the cover 606 is ultrasonically welded to the temple arm frame 602. The seal formed between the cover 606 and the temple arm frame 602 may prevent intrusion of foreign objects and environmental contaminants into the battery compartment. When the hermetic coating 608 is applied to interior surfaces of both the temple arm frame 602 and the cover 606, the seal formed by the cover 606 may work in conjunction with the hermetic coating 608 to provide moisture barrier properties for the electrode stack 604.

The battery may have a flexural rigidity between 2 Nm² and 10 Nm². The flexural rigidity may be tuned by adjusting mechanical properties of the polymer electrolyte disposed within the electrode stack 604. The tunable flexural rigidity enables the battery to provide structural support to the temple arm 600 while accommodating mechanical deformation during use.

The battery may be configured to maintain at least 80% capacity retention after 11,000 bend cycles. The battery may be configured to withstand greater than 20,000 bend cycles at a 10 mm bend radius. The battery may be configured to maintain greater than 500 charge cycles. The battery may have an elastic recovery of 98% after cyclic bending. The elastic recovery enables the battery to return to an original shape after mechanical deformation without permanent deformation that could degrade battery performance.

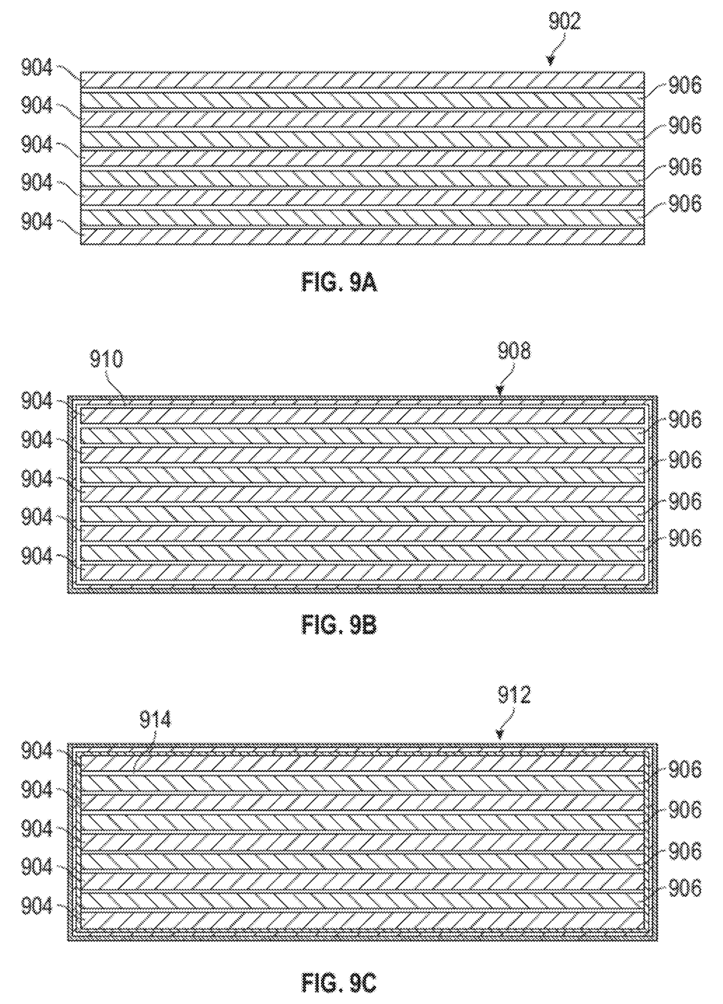

FIGS. 7A-7D illustrate an example method of assembling a temple arm housing a structural battery and an electrical component, in accordance with some embodiments.

Referring to FIG. 7A, in some embodiments, the temple arm frame 702 is configured to receive the electrode stack 704 within a channel or cavity formed along a length of the temple arm frame 702. The temple arm frame 702 is configured to couple to the inner cover 706 to enclose the electrode stack 704 within a battery compartment. The temple arm frame 702 is further configured to couple to the outer cover 710 to enclose the electrical components 708 within the temple arm 700. When the inner cover 706 is attached to the temple arm frame 702, the electrode stack 704 is enclosed within a sealed compartment formed by the temple arm frame 702 and the inner cover 706. When the outer cover 710 is attached to the temple arm frame 702, the electrical components 708 and the inner cover 706 are enclosed within the temple arm 700.

The temple arm frame 702 may have an elongated shape with a curved portion that follows a contour typical of eyewear temple arms. While not shown, it should be appreciated that, in some embodiments, the electrode stack 704 (e.g., a terraced electrode stack) may be configured to be disposed within the curved portion of the temple arm frame 702 with a corresponding inner cover.

Referring to FIGS. 7B, the temple arm frame 702 and the inner cover 706 are shown with a hermetic coating 712 applied to interior surfaces. The hermetic coating 712 is applied to an interior surface of the temple arm frame 702 and the inner cover 706 prior to disposing the electrode stack 704 within the temple arm frame 702. The hermetic coating 712 provides a moisture barrier that protects the electrode stack 704 from environmental exposure when the temple arm 700 is assembled.

With reference to FIG. 7C, when the electrode stack 704 is disposed within the temple arm frame 702 and sealed with the inner cover 706, a polymer electrolyte may be injected into the assembly such that the polymer electrolyte contacts the hermetic coating 712 and fills spaces between electrode layers of the electrode stack 704. Curing of the polymer electrolyte bonds the polymer electrolyte to the hermetic coating 712 and to the electrode layers of the electrode stack 704. Polymerization of the electrolyte causes the electrolyte to be bonded to the hermetic coating 712 of the inner cover 706. In this manner, the structural battery forms a portion of the mechanical structure of the temple arm 700. The bonding of the polymer electrolyte to both the hermetic coating 712 and the electrode layers creates a mechanically integrated assembly in which the structural battery contributes to the overall rigidity of the temple arm 700.

The inner cover 706 may be attached to the temple arm frame 702 using various sealing techniques. In some embodiments, the inner cover 706 is heat sealed to the temple arm frame 702 using polypropylene or other thermoplastic materials that form a bond when heated. In some embodiments, the inner cover 706 is adhesively bonded to the temple arm frame 702 using pressure sensitive adhesive or UV cure adhesive. In some embodiments, the inner cover 706 is ultrasonically welded to the temple arm frame 702. The seal formed between the inner cover 706 and the temple arm frame 702 may prevent intrusion of foreign objects and environmental contaminants into the battery compartment. When the hermetic coating 712 is applied to interior surfaces of both the temple arm frame 702 and the inner cover 706, the seal formed by the inner cover 706 may work in conjunction with the hermetic coating 712 to provide moisture barrier properties for the electrode stack 704.

The electrical components 708 are disposed over the inner cover 706 after the electrode stack 704 is sealed within the battery compartment. With reference to FIG. 7D, the outer cover 710 is then attached to the temple arm frame 702 to enclose the electrical components 708 and the inner cover 706 within the temple arm 700. The layered configuration enables integration of battery components directly into the temple arm structure while accommodating additional electrical components in a space-efficient manner. The inner cover 706 seals the battery compartment while allowing the electrical components 708 to be routed above the inner cover 706, and the outer cover 710 encloses both the electrical components 708 and the inner cover 706. In some embodiments, the inner cover 706 forms a seal with the temple arm frame 702 that contains the polymer electrolyte within the battery compartment, preventing the polymer electrolyte from migrating to the region where the electrical components 708 are disposed.

In some embodiments, the polymer electrolyte may be injected through a sealable port in the temple arm frame 702 or the inner cover 706, followed by sealing of the port after electrolyte injection and curing.

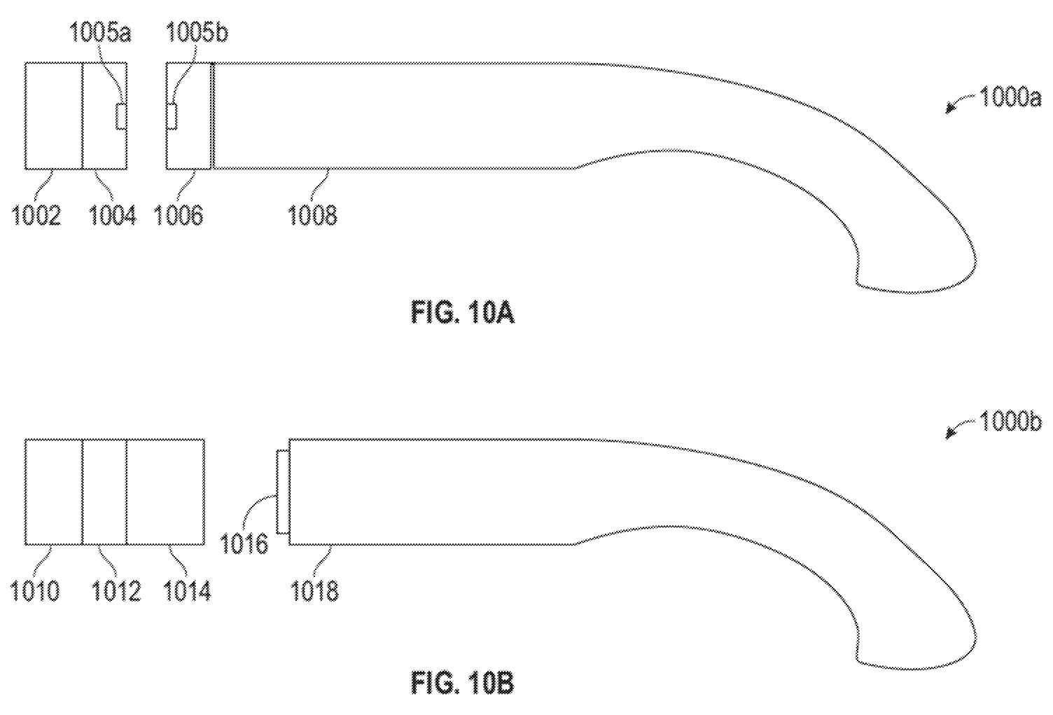

FIGS. 8A-8C illustrate a first example method of separately assembling a structural battery, in accordance with some embodiments.

As shown in FIG. 8A, the electrode stack 802 comprises multiple alternating layers arranged in a stacked configuration. The electrode stack 802 includes alternating layers, which represent anode layers 804 and cathode layers 806 of a battery cell. The electrode stack 802 forms a foundation of a battery cell prior to application of polymer electrolyte and hermetic coating.

In some embodiments, the electrode stack 802 can be arranged in a rolled configuration rather than a stacked configuration. The rolled configuration comprises continuous anode and cathode layers wound around a central axis, with a separator material disposed between the anode layers 804 and cathode layers 806.

As shown in FIG. 8B, a polymer electrolyte is injected into the electrode stack 802. The polymer electrolyte 810 may be injected in a liquid or semi-liquid state, allowing the polymer electrolyte to flow between and around the electrode layers of the electrode stack 802. The polymer electrolyte fills spaces between adjacent anode layers 804 and cathode layers 806, establishing ionic conduction pathways throughout the electrode stack 802. Following injection, the polymer electrolyte is cured to form the polymerized electrode stack 808. Curing may be accomplished through thermal curing, UV curing, or other polymerization techniques depending on the specific polymer electrolyte chemistry employed. During curing, the polymer electrolyte 810 transitions from a liquid or semi-liquid state to a solid state, bonding to the surfaces of the anode layers 804 and cathode layers 806. The cured polymer electrolyte 810 provides mechanical support to the polymerized electrode stack 808, enabling the battery to function as a structural component while maintaining ionic conductivity for electrochemical operation. The polymer electrolyte 810 may have a tunable elastic modulus configured to provide a selected flexural rigidity for the structural battery. The tunable elastic modulus enables adjustment of mechanical properties by modifying polymer chemistry during fabrication.

As shown in FIG. 8C, the polymerized electrode stack 808is encased in a hermetic coating to form the hermetically sealed polymerized electrode stack 812. The hermetic coating is applied around the polymerized electrode stack 808 to provide moisture barrier properties that protect the electrode stack from environmental exposure. The hermetic coating 814 may comprise multiple layers, including a flexible layer (e.g., flexible layer 506, as shown in FIG. 5) that supports the hermetic coating during cyclic deformation, a hermetic layer (e.g., hermetic layer 504, as shown in FIG. 5) that prevents moisture ingress into the electrode stack and the polymer electrolyte, and a protective layer (e.g., protective layer 502, as shown in FIG. 5) that at least partially seals the hermetic layer from environmental exposure and moisture ingress. The hermetic coating 814 may be applied via atomic layer deposition, chemical vapor deposition, or other deposition techniques suitable for forming thin, conformal barrier layers around the polymerized electrode.

The hermetically sealed polymerized electrode stack 812 may be a completed battery cell that combines the structural benefits of the polymerized electrolyte with the protective properties of hermetic sealing. The polymerized electrolyte provides mechanical support to the electrode stack and enables the battery to function as a structural component, while the hermetic coating maintains moisture barrier properties to ensure long-term battery performance. This configuration enables integration of the hermetically sealed polymerized electrode stack 812 into wearable devices such as smart glasses temple arms, where the battery may contribute to the structural rigidity of the device housing while providing energy storage functionality.

In some embodiments, a first method of separately assembling a structural battery comprises fabricating the electrode stack 802, injecting and curing a polymer electrolyte to form the polymerized electrode stack 804, and applying a hermetic coating to form the hermetically sealed polymerized electrode stack 812. In this sequence, polymerization of the electrolyte occurs before hermetic sealing. The polymer electrolyte may be injected into the electrode stack 802 while the electrode stack 802 is positioned in a shaped mold, and curing of the polymer electrolyte locks in a desired shape including any required curvature.

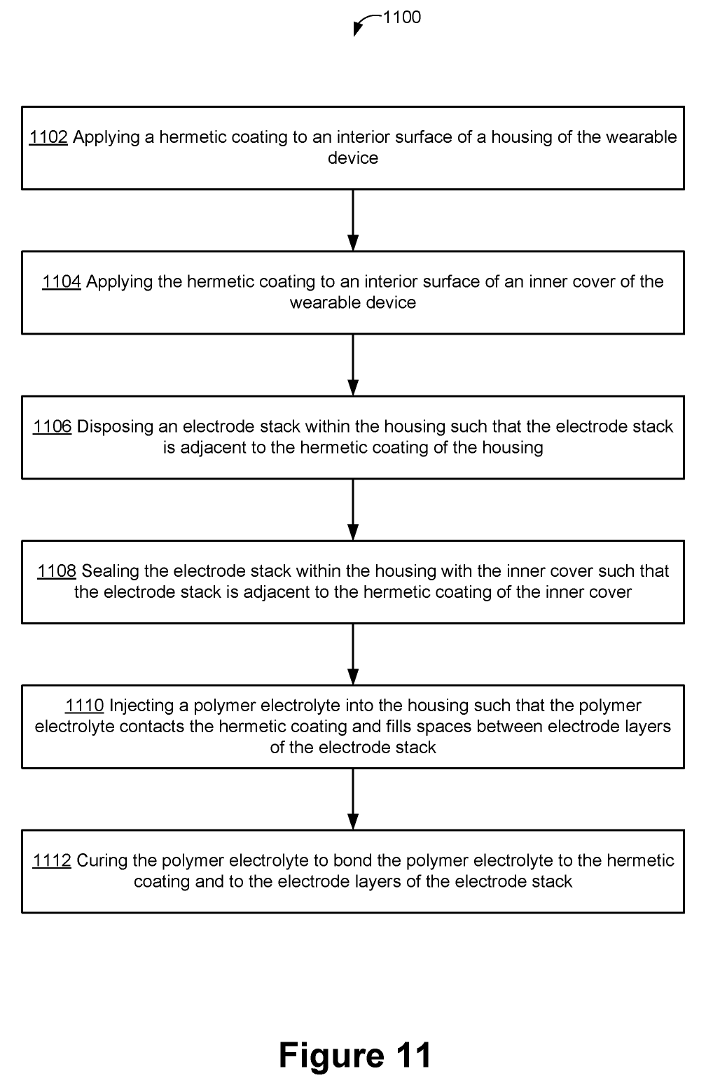

FIGS. 9A-9C illustrate a second example method of separately assembling a structural battery, in accordance with some embodiments.

As shown in FIG. 9A, the electrode stack 902 comprises multiple alternating layers arranged in a stacked configuration. The electrode stack 902 includes alternating layers, which represent anode layers 904 and cathode layers 906 of a battery cell. The layers are arranged horizontally and extend across a width of the electrode stack 902. The electrode stack 902 forms a foundation of a battery cell prior to application of hermetic coating and polymer electrolyte. The electrode stack 902 may be configured with uniform layer dimensions as shown, or may alternatively be configured with varying layer dimensions to form a terraced structure for integration into non-rectilinear spaces within a device such as a temple arm of smart glasses.

In some embodiments, the electrode stack 902 can be arranged in a rolled configuration rather than a stacked configuration. The rolled configuration comprises continuous anode and cathode layers wound around a central axis, with a separator material disposed between the anode layers 904 and cathode layers 906.

As shown in FIG. 9B, a hermetic coating 910 is applied around the electrode stack 902 to form the hermetically sealed electrode stack 908. The hermetic coating 910 is applied around the electrode stack 902 to provide moisture barrier properties that protect the electrode stack 902 from environmental exposure. The hermetic coating 910 may comprise multiple layers, including a flexible layer (e.g., flexible layer 506, as shown in FIG. 5) that supports the hermetic coating during cyclic deformation, a hermetic layer (e.g., hermetic layer 504, as shown in FIG. 5) that prevents moisture ingress into the electrode stack and the polymer electrolyte, and a protective layer (e.g., protective layer 502, as shown in FIG. 5) that at least partially seals the hermetic layer from environmental exposure and moisture ingress. The hermetic coating 910 may be applied via atomic layer deposition, chemical vapor deposition, or other deposition techniques suitable for forming thin, conformal barrier layers around the polymerized electrode.

The hermetic coating of the hermetically sealed electrode stack 908 includes a port 912 configured to enable injection of a polymer electrolyte into the electrode stack. The port 912 provides an opening through the hermetic coating that allows the polymer electrolyte to be introduced into the hermetically sealed electrode stack 908 after the hermetic coating 910 has been applied. The port 912 may be positioned at an edge or corner of the hermetically sealed electrode stack 908 to facilitate electrolyte injection while minimizing impact on the hermetic seal integrity.

As shown in FIG. 9C, a polymer electrolyte has been injected through the port 912 into the hermetically sealed electrode stack 908 to form the hermetically sealed polymerized electrode stack 916. The polymer electrolyte 914 may be injected through the port 912 under pressure to fill spaces between electrode layers of the hermetically sealed electrode stack 908. The polymer electrolyte 914 fills spaces between adjacent anode layers and cathode layers, establishing ionic conduction pathways throughout the electrode stack. Following injection, the polymer electrolyte 914 is cured to form the hermetically sealed polymerized electrode stack 916. Curing may be accomplished through thermal curing, UV curing, or other polymerization techniques depending on the specific polymer electrolyte chemistry employed. During curing, the polymer electrolyte 914 transitions from a liquid or semi-liquid state to a solid state, bonding to the surfaces of the anode layers 904 and cathode layers 906. The cured polymer electrolyte 914 provides mechanical support to the hermetically sealed polymerized electrode stack 916, enabling the battery to function as a structural component while maintaining ionic conductivity for electrochemical operation. The polymer electrolyte 914 may have a tunable elastic modulus configured to provide a selected flexural rigidity for the structural battery. The tunable elastic modulus enables adjustment of mechanical properties by modifying polymer chemistry during fabrication.

After injection of the polymer electrolyte 914, the port 912 is sealed to maintain hermeticity of the completed battery cell. The port may be sealed using heat sealing, adhesive bonding, or other sealing techniques compatible with the hermetic coating materials. The port may be sealed using a second application of a hermetic coating. The sealed port maintains the moisture barrier properties of the hermetic coating after electrolyte injection and curing are complete.

The hermetically sealed polymerized electrode stack 916 represents a completed battery cell that combines the structural benefits of the polymerized electrolyte with the protective properties of hermetic sealing. This second method, in which hermetic sealing occurs before polymerization of the electrolyte, may be advantageous when the hermetic coating materials or processes are incompatible with exposure to uncured polymer electrolyte. By applying the hermetic coating before electrolyte injection, the second method enables use of hermetic coating materials that may be sensitive to chemical exposure during the electrolyte curing process. The second method may also be advantageous because it may require less space, as the hermetic layer defines the space for the polymer electrolyte 914, potentially enabling a more compact battery assembly. The port provides a controlled pathway for electrolyte introduction while maintaining the protective function of the hermetic coating during the injection and curing steps.

In some embodiments, the separately assembled battery can be disposed in or coupled to the temple arm via adhesives (e.g., pressure sensitive adhesives). In some embodiments, multiple batteries can be disposed within the temple arm.

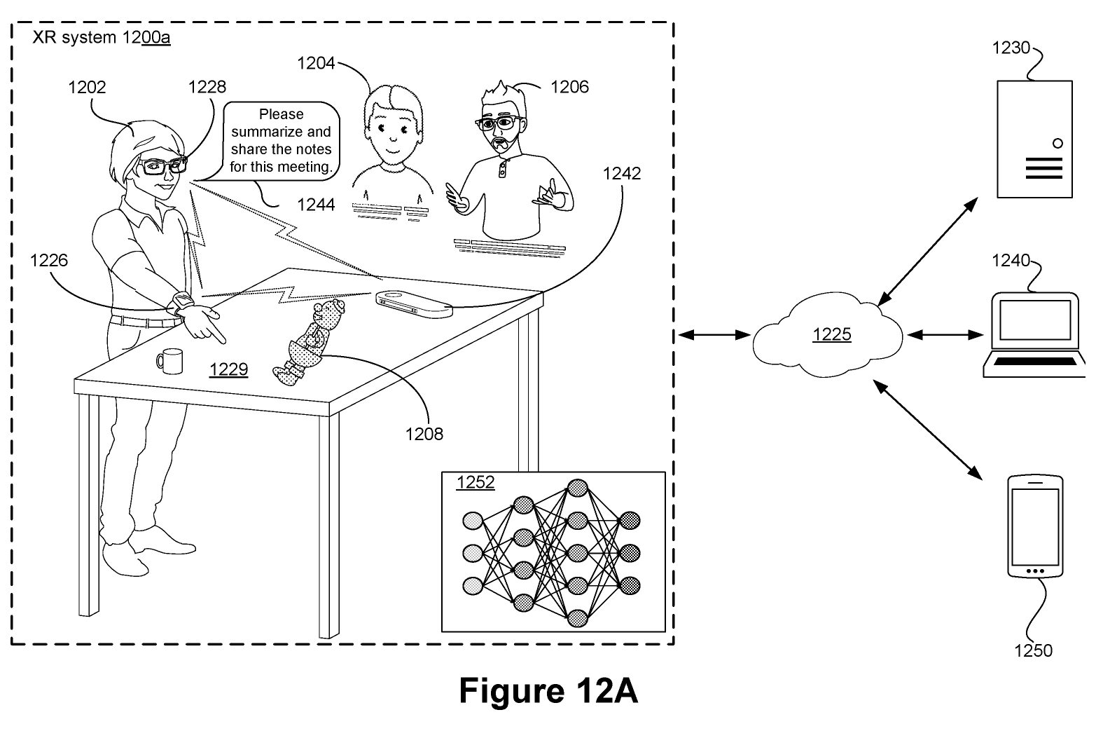

In some embodiments, a pair of smart glasses includes a lens frame and a pair of temple arms. Each temple arm may be coupled to the lens frame via a respective hinge. The hinges may enable the temple arms to pivot relative to the lens frame, allowing the smart glasses to be folded for storage or unfolded for wearing. At least one of the temple arms includes a structural battery as described herein. The structural battery may be integrated into the temple arm such that the battery provides both energy storage functionality and structural support to the temple arm. In some embodiments, both temple arms include structural batteries, which may increase the total energy storage capacity of the smart glasses. The temple arms may extend from the lens frame and curve to conform to a user's head when the smart glasses are worn. FIGS. 10A-10B illustrate example removable temple arm assemblies in a first configuration and in a second configuration, in accordance with some embodiments. The removable temple arm assemblies may enable battery replacement or servicing of the smart glasses without requiring replacement of the entire device.

FIG. 10A depicts a temple arm assembly 1000a in a first configuration. The temple arm assembly 1000a includes a lens frame 1002 positioned at a front of the smart glasses. The lens frame 1002 connects to a lens frame hinge 1004. The lens frame hinge 1004 couples to a temple arm hinge 1006, which in turn connects to a temple arm 1008. The temple arm 1008 extends rearward and curves downward at a distal end of the temple arm 1008 to conform to a shape of a user's head. In the first configuration, the temple arm assembly 1000a is separable at the hinge between the lens frame 1002 and the temple arm 1008. The lens frame hinge 1004 and the temple arm hinge 1006 may be configured as a first hinge component and a second hinge component, respectively. The first hinge component may be coupled to the lens frame 1002, and the first hinge component may include a first connector. The second hinge component may be coupled to the temple arm 1008, and the second hinge component may include a second connector configured to removably couple to the first connector of the first hinge component. The separable hinge components enable the temple arm assembly 1000a to be removable, allowing the temple arm 1008 to be detached from the lens frame 1002 for battery replacement or servicing.

FIG. 10B depicts a temple arm assembly 1000b in a second configuration. The temple arm assembly 1000b includes a lens frame 1010 at a front of the smart glasses. The lens frame 1010 connects to a hinge 1012. The hinge 1012 couples to a front temple arm 1014. A temple arm connector 1016 joins the front temple arm 1014 to a rear temple arm 1018. The rear temple arm 1018 extends rearward and curves downward at a distal end of the rear temple arm 1018. In the second configuration, the temple arm assembly 1000b is separable along the temple arm, between the front temple arm 1014 and the rear temple arm 1018. The temple arm connector 1016 enables the rear temple arm 1018 to be removable from the front temple arm 1014, which facilitates battery replacement or servicing of the smart glasses.

In both the first configuration and the second configuration, the separation points provide mechanical, thermal, and electrical connections. In the first configuration, the first connector 1005a and the second connector 1005b of the lens frame hinge 1004 and the temple arm hinge 1006, respectively, provide mechanical, thermal, and electrical connections between the lens frame 1002 and the temple arm 1008. The mechanical connections of the first connector 1005a and second connector 1005b (and, optionally, the lens frame hinge 1004 and the temple arm hinge 1006) enable secure attachment of the temple arm 1008 to the lens frame 1002 while allowing removal when battery replacement or servicing is desired. The electrical connections of the first connector 1005a second connector 1005b enable power and data transfer between components disposed in the lens frame 1002 and components disposed in the temple arm 1008, including the structural battery. The thermal connections of the first connector 1005a and second connector 1005b enable heat transfer between the lens frame 1002 and the temple arm 1008, which may facilitate thermal management of the structural battery and other heat-generating components within the temple arm assembly 1000a.

In the second configuration, the temple arm connector 1016 provides mechanical, thermal, and electrical connections between the front temple arm 1014 and the rear temple arm 1018. The mechanical connections of the temple arm connector 1016 enable secure attachment of the rear temple arm 1018 to the front temple arm 1014 while allowing removal when battery replacement or servicing is desired. The electrical connections of the temple arm connector 1016 enable power and data transfer between components disposed in the front temple arm 1014 and components disposed in the rear temple arm 1018, including the structural battery. The thermal connections of the temple arm connector 1016 enable heat transfer between the front temple arm 1014 and the rear temple arm 1018, which may facilitate thermal management of the structural battery and other heat-generating components within the temple arm assembly 1000b.

A method of manufacturing a wearable device with an integrated structural battery may further comprise overmolding a housing with a thermoplastic such that the housing is encapsulated by the thermoplastic. Overmolding techniques enable direct formation of cosmetic packaging over the structural battery. The overmolding process encapsulates the battery within the temple arm housing, providing both structural support and a cosmetic exterior surface.

Cosmetic packaging materials may comprise various thermoplastic materials suitable for eyewear applications. In some embodiments, the cosmetic packaging includes TR90, which is a nylon-based material that provides mechanical properties suitable for temple arm applications while enabling cosmetic finishes compatible with consumer eyewear products. In some embodiments, the cosmetic packaging includes polypropylene, which provides a lower processing temperature compared to other thermoplastic materials, which may reduce thermal exposure to the structural battery during the overmolding process. The lower processing temperature may reduce the chances that the battery is damaged during the overmolding process.

The cosmetic packaging may be applied via low pressure molding (LPM). In some embodiments, the cosmetic packaging is applied via low pressure molding at temperatures of 100-200°C and pressures less than 100 MPa. Low pressure molding provides reduced mechanical stress on the structural battery compared to conventional injection molding processes, which may operate at pressures of 300-1200 MPa. The lower pressure of the LPM process reduces risk of damage to the electrode stack and hermetic coating during the overmolding operation. Low pressure molding may produce wall thicknesses of 0.8 mm or greater depending on flow length requirements. Weld line formation may occur during low pressure molding depending on gate location, and the hermetic coating of the structural battery provides moisture barrier protection in regions where weld lines may be present in the cosmetic packaging.

The cosmetic packaging may be applied via compression molding. In some embodiments, the cosmetic packaging is applied via compression molding at temperatures of 100-300°C and pressures of 100-300 MPa. Compression molding provides intermediate pressure levels between low pressure molding and conventional injection molding. The compression molding process may accommodate various thermoplastic materials including polypropylene, polycarbonate, PET, and polyamide materials. Compression molding may be performed with composite materials such as carbon fiber reinforced polymers to achieve reduced wall thicknesses while maintaining structural integrity of the temple arm.

The cosmetic packaging may be applied via thermoforming. In some embodiments, the cosmetic packaging is applied via thermoforming at temperatures of 60-150°C. Thermoforming provides a low-temperature process for applying cosmetic packaging to the structural battery. The thermoforming process involves heating a thermoplastic sheet to a pliable forming temperature and shaping the sheet over the structural battery using vacuum, pressure, or mechanical force. Thermoforming may produce wall thicknesses of 0.05 mm or greater. Thickness variation may occur during thermoforming based on draw ratio, and the hermetic coating of the structural battery provides moisture barrier protection independent of cosmetic packaging thickness variations.

The cosmetic packaging may be applied via outside of mold lamination (OML). In some embodiments, the cosmetic packaging is applied via outside of mold lamination at temperatures of 60-150°C. Outside of mold lamination provides a low-temperature process similar to thermoforming for applying cosmetic packaging to the structural battery. The OML process involves laminating a pre-formed thermoplastic film over the structural battery to provide cosmetic and protective functions. Outside of mold lamination may produce wall thicknesses of 0.05 mm or greater. The OML process may accommodate various thermoplastic materials including PET, PI, PA, and PP materials.

The structural battery may include a battery management unit (BMU) that is molded or integrated into the battery. The battery management unit may be disposed within the temple arm and encapsulated by the cosmetic packaging during the overmolding process. Integration of the battery management unit into the structural battery assembly reduces component count and simplifies electrical connections within the temple arm. The battery management unit may be positioned adjacent to electrical contacts of the electrode stack to minimize routing distance for power and data connections. The overmolding process encapsulates both the structural battery and the battery management unit within the thermoplastic housing, providing protection for both components while maintaining electrical accessibility through appropriate connector features formed in the cosmetic packaging.

The structural battery architecture described herein may be adapted to various wearable device configurations beyond smart glasses. The polymer electrolyte, hermetic coating, and terraced electrode stack configurations provide benefits of reduced weight, improved flexibility, and conformance to curved geometries that are applicable across multiple wearable device form factors, such as smart watches, rings, wrist-wearable device, headset, headphones, earbuds, and other wearable devices.

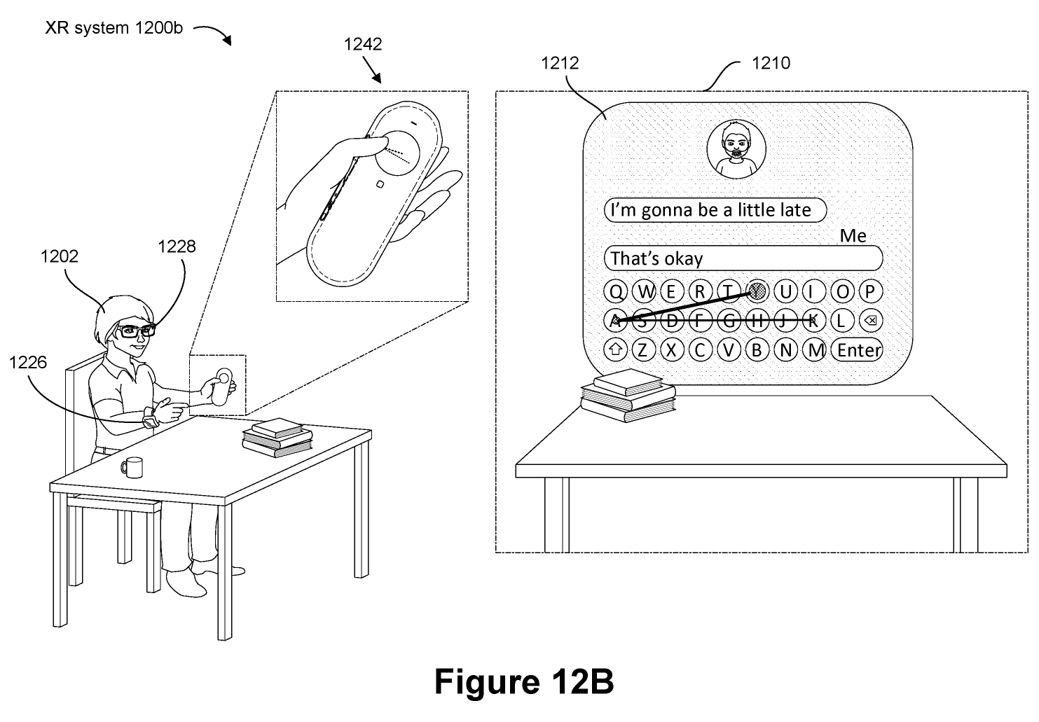

FIG. 11 illustrates an example method flow chart for manufacturing a wearable device with a structural battery, in accordance with some embodiments. Operations (e.g., steps) of the method 1100 can be performed by one or more processors (e.g., central processing unit and/or MCU) of a system for manufacturing a wearable device with a structural battery At least some of the operations shown in FIG. 11 correspond to instructions stored in a computer memory or computer-readable storage medium (e.g., storage, RAM, and/or memory) for manufacturing a wearable device with a structural battery. Operations of the method 1100 can be performed by a single device alone or in conjunction with one or more processors and/or hardware components of another communicatively coupled device and/or instructions stored in memory or computer-readable medium of the other device communicatively coupled to the system for manufacturing a wearable device with a structural battery. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) FIG. 11 shows a flow chart of a method 1100 of manufacturing a wearable device with a structural battery, in accordance with some embodiments.

In some embodiments, the method 1100 includes, applying (1102) a hermetic coating (e.g., hermetic coating 608 as shown in FIGS. 6B-6D or hermetic coating 712 as shown in FIGS. 7B-7D) to an interior surface of a housing of the wearable device. The housing may be a temple arm frame (e.g., temple arm frame 602 as shown in FIGS. 6A-6D or temple arm frame 702 as shown in FIGS. 7A-7D) of smart glasses or another wearable device housing configured to receive a structural battery. The hermetic coating provides moisture barrier properties that protect battery components from environmental exposure.

In some embodiments, the method 1100 includes, applying (1104) a hermetic coating to an interior surface of an inner cover (e.g., inner cover 706 as shown in FIGS. 7A-7D) of the wearable device. The inner cover is configured to seal an electrode stack within the housing. Applying the hermetic coating to both the housing and the inner cover enables the electrode stack to be surrounded by hermetically coated surfaces when the inner cover is attached to the housing.

In some embodiments, the method 1100 includes, disposing (1106) an electrode stack (e.g., electrode stack 604 as shown in FIGS. 6A-6C or electrode stack 704 as shown in FIGS. 7A-7C) within the housing such that the electrode stack is adjacent to the hermetic coating of the housing. The electrode stack may comprise a plurality of anode layers and cathode layers arranged in an alternating configuration. In some embodiments, the electrode stack has a terraced configuration (e.g., terraced electrode stack 202 as shown in FIG. 2 or terraced electrode stack 402 as shown in FIG. 4) in which electrode layers have varying dimensions to conform to curved or non-rectilinear geometries of the housing.

In some embodiments, the method 1100 includes, sealing (1108) the electrode stack within the housing with the inner cover (e.g., cover 606 as shown in FIGS. 6A-6D or inner cover 706 as shown in FIGS. 7A-7D) such that the electrode stack is adjacent to the hermetic coating of the inner cover. The inner cover may be attached to the housing using heat sealing, adhesive bonding, ultrasonic welding, or other sealing techniques.

In some embodiments, the method 1100 includes, injecting (1110) a polymer electrolyte (e.g., structural electrolyte 306 as shown in FIG. 3) into the housing such that the polymer electrolyte contacts the hermetic coating and fills spaces between electrode layers of the electrode stack. The polymer electrolyte may be injected in a liquid or semi-liquid state through a port in the housing or the inner cover.

In some embodiments, the method 1100 includes, curing (1112) the polymer electrolyte to bond the polymer electrolyte to the hermetic coating and to the electrode layers of the electrode stack. Curing may be accomplished through thermal curing, UV curing, or other polymerization techniques. The cured polymer electrolyte provides mechanical support to the electrode stack and creates a mechanically integrated assembly in which the structural battery contributes to the overall rigidity of the wearable device housing.

(A2) In some embodiments of A1, the method further includes disposing an electrical component (e.g., electrical components 708 as shown in FIGS. 7A-7C) over the inner cover and sealing the housing with an outer cover (e.g., outer cover 710 as shown in FIGS. 7A-7D), where the outer cover encloses the electrical component, the inner cover, and the electrode stack within the housing.

(A3) In some embodiments of any of A1-A2, the method further includes overmolding the housing with a thermoplastic such that the housing is encapsulated by the thermoplastic.

(B1) In accordance with some embodiments, a pair of smart glasses (e.g., smart glasses 100 as shown in FIG. 1B, smart glasses 200 as shown in FIG. 2, or smart glasses 300 as shown in FIG. 3) includes a temple arm and a battery disposed within a temple arm such that an electrolyte of the battery is in contact with portion of the temple arm that is coated in a hermetic coating, where the electrolyte is polymerized so that the electrolyte is bonded to the hermetic coating of the temple arm.

(B2) In some embodiments of B1, the battery is mechanically coupled to the temple arm such that mechanical forces applied to the temple arm are at least partially supported by the battery and the battery is configured to withstand cyclic deformation without degradation of battery performance.

(B3) In some embodiments of any of B1-B2, the battery comprises an electrode stack having a terraced configuration (e.g., terraced electrode stack 202 as shown in FIG. 2 or terraced electrode stack 402 as shown in FIG. 4), where a first layer of the electrode stack has a different geometry than a second layer of the electrode stack.

(B4) In some embodiments of any of B1-B3, the electrode stack is a non-cuboidal shape (e.g., as shown in FIGS. 1, 2, and 4) , and the electrode stack conforms to a curved geometry of the temple arm (e.g., curved portion 112 as shown in FIG. 1B).

(B5) In some embodiments of any of B1-B4, the portion of the temple arm further comprises a substrate layer (e.g., substrate 508 as shown in FIG. 5) disposed between the temple arm and a flexible layer. The flexible layer (e.g., flexible layer 506 as shown in FIG. 5) is disposed on the substrate layer, where the flexible layer is configured to enable the hermetic coating to tolerate cyclic deformation. The hermetic coating (e.g., hermetic layer 504 as shown in FIG. 5) is disposed on the flexible layer, where the hermetic coating forms a seal around the battery that prevents moisture ingress into the battery. A protective layer (e.g., protective layer 502 as shown in FIG. 5) is disposed on the hermetic layer, where the protective layer is configured to at least partially seal the hermetic coating from environmental exposure.

(B6) In some embodiments of any of B1-B5, the smart glasses further include an inner cover (e.g., inner cover 706 as shown in FIGS. 7A-7D) disposed within the temple arm and coupled to the battery, where the inner cover is coated in the hermetic coating and polymerization of the electrolyte causes the electrolyte to be bonded to the hermetic coating of the inner cover, an electrical component (e.g., electrical components 708 as shown in FIGS. 7A-7C), and an outer cover (e.g., outer cover 710 as shown in FIGS. 7A-7D) configured to at least partially seal the temple arm, where the outer cover encloses the electrical component and the inner cover within the temple arm.

(B7) In some embodiments of any of B1-B6, the temple arm includes a front portion of the temple arm (e.g., front temple arm 1014 as shown in FIG. 10B), a rear portion of the temple arm (e.g., rear temple arm 1018 as shown in FIG. 10B), and a connector (e.g., temple arm connector 1016 as shown in FIG. 10B) configured to removably couple the front portion of the temple arm and the rear portion of the temple arm. The smart glasses further include a lens frame (e.g., lens frame 1010 as shown in FIG. 10B) and a hinge (e.g., hinge 1012 as shown in FIG. 10B) coupled to the lens frame and the front portion of the temple arm.

(B8) In some embodiments of any of B1-B7, the smart glasses further include a lens frame (e.g., lens frame 1002 as shown in FIG. 10A) and a hinge including a first hinge component (e.g., lens frame hinge 1004 as shown in FIG. 10A) and a second hinge component (e.g., temple arm hinge 1006 as shown in FIG. 10A). The first hinge component is coupled to the lens frame, where the first hinge component includes a first connector. The second hinge component is coupled to the temple arm (e.g., temple arm 1008 as shown in FIG. 10A), where the second hinge component includes a second connector configured to removably couple to the first connector of the first hinge component.

(B9) In some embodiments of any of B1-B8, the battery has a flexural rigidity between 2 Nm² and 10 Nm².

(B10) In some embodiments of any of B1-B9, the battery is configured to maintain at least 80% capacity retention after 11,000 bend cycles.

(B11) In some embodiments of any of B1-B10, the electrolyte comprises a polymer electrolyte having a tunable elastic modulus.

(C1) In accordance with some embodiments, a structural battery for a wearable device (e.g., as shown in FIGS. 3, 8A-8C, and 9A-9C) includes an electrode stack comprising a plurality of anode layers and a plurality of cathode layers arranged in an alternating configuration, a polymer electrolyte disposed between the plurality of anode layers and the plurality of cathode layers, where the polymer electrolyte provides mechanical support to the electrode stack, and a hermetic coating disposed around the electrode stack and the polymer electrolyte, where the polymer electrolyte is bonded to the hermetic coating.

(C2) In some embodiments of C1, the electrode stack has a terraced configuration (e.g., terraced electrode stack 202 as shown in FIG. 2 or terraced electrode stack 402 as shown in FIG. 4) in which the plurality of anode layers and the plurality of cathode layers have varying dimensions to form a non-cuboidal shape.

(C3) In some embodiments of any of C1-C2, the hermetic coating comprises a hermetic layer (e.g., hermetic layer 504 as shown in FIG. 5) encapsulating the electrode stack to prevent moisture ingress into the electrode stack and the polymer electrolyte, a flexible layer (e.g., flexible layer 506 as shown in FIG. 5) disposed on a first side of the hermetic layer to support the hermetic coating during cyclic deformation, and a protective layer (e.g., protective layer 502 as shown in FIG. 5) disposed on a second side of the hermetic layer, opposite the first side, that at least partially seals the hermetic layer from environmental exposure.

(C4) In some embodiments of any of C1-C3, the polymer electrolyte has a tunable elastic modulus configured to provide a selected flexural rigidity for the structural battery.

(C5) In some embodiments of any of C1-C4, the hermetic coating includes a port (e.g., as shown in FIGS. 9B-9C) configured to enable injection of the polymer electrolyte into the electrode stack, where the port is sealed after injection of the polymer electrolyte.

(C6) In some embodiments of any of C1-C5, the structural battery has a flexural rigidity between 2 Nm² and 10 Nm² and the battery is configured to maintain at least 80% capacity retention after 11,000 bend cycles.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

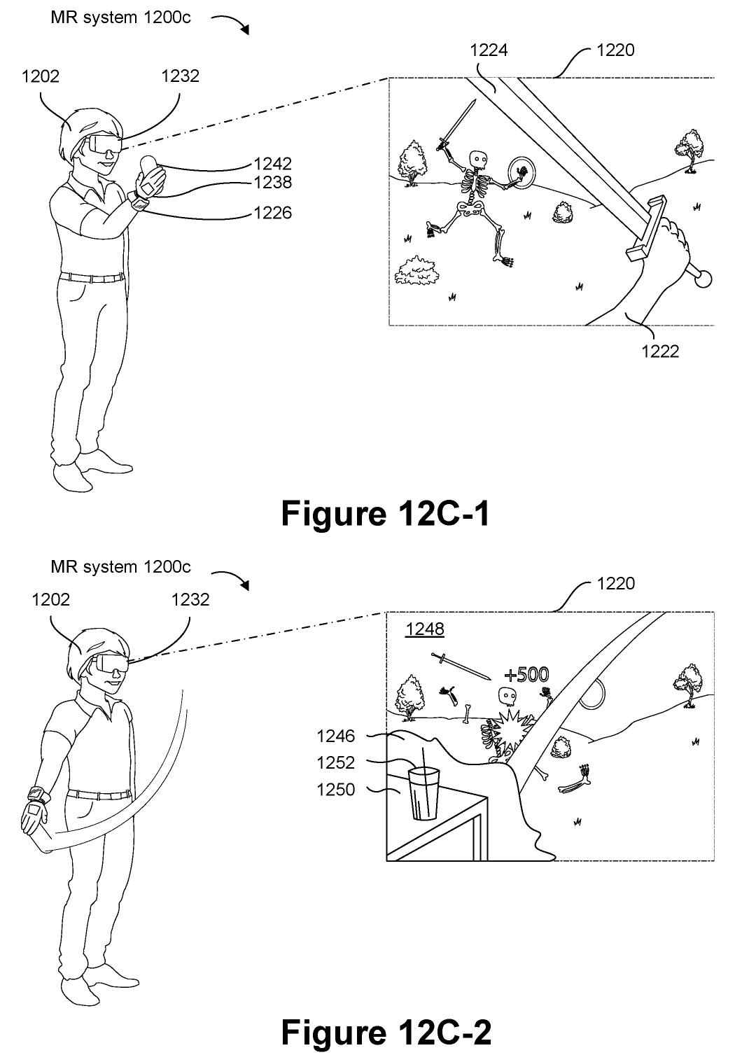

FIGS. 12A 12B, 12C-1, and 12C-2, illustrate example XR systems that include AR and MR systems, in accordance with some embodiments. FIG. 12A shows a first XR system 1200a and first example user interactions using a wrist-wearable device 1226, a head-wearable device (e.g., AR device 1228), and/or a HIPD 1242. FIG. 12B shows a second XR system 1200b and second example user interactions using a wrist-wearable device 1226, AR device 1228, and/or an HIPD 1242. FIGS. 12C-1 and 12C-2 show a third MR system 1200c and third example user interactions using a wrist-wearable device 1226, a head-wearable device (e.g., an MR device such as a VR device), and/or an HIPD 1242. As the skilled artisan will appreciate upon reading the descriptions provided herein, the above-example AR and MR systems (described in detail below) can perform various functions and/or operations.

The wrist-wearable device 1226, the head-wearable devices, and/or the HIPD 1242 can communicatively couple via a network 1225 (e.g., cellular, near field, Wi-Fi, personal area network, wireless LAN). Additionally, the wrist-wearable device 1226, the head-wearable device, and/or the HIPD 1242 can also communicatively couple with one or more servers 1230, computers 1240 (e.g., laptops, computers), mobile devices 1250 (e.g., smartphones, tablets), and/or other electronic devices via the network 1225 (e.g., cellular, near field, Wi-Fi, personal area network, wireless LAN). Similarly, a smart textile-based garment, when used, can also communicatively couple with the wrist-wearable device 1226, the head-wearable device(s), the HIPD 1242, the one or more servers 1230, the computers 1240, the mobile devices 1250, and/or other electronic devices via the network 1225 to provide inputs.

Turning to FIG. 12A, a user 1202 is shown wearing the wrist-wearable device 1226 and the AR device 1228 and having the HIPD 1242 on their desk. The wrist-wearable device 1226, the AR device 1228, and the HIPD 1242 facilitate user interaction with an AR environment. In particular, as shown by the first AR system 1200a, the wrist-wearable device 1226, the AR device 1228, and/or the HIPD 1242 cause presentation of one or more avatars 1204, digital representations of contacts 1206, and virtual objects 1208. As discussed below, the user 1202 can interact with the one or more avatars 1204, digital representations of the contacts 1206, and virtual objects 1208 via the wrist-wearable device 1226, the AR device 1228, and/or the HIPD 1242. In addition, the user 1202 is also able to directly view physical objects in the environment, such as a physical table 1229, through transparent lens(es) and waveguide(s) of the AR device 1228. Alternatively, an MR device could be used in place of the AR device 1228 and a similar user experience can take place, but the user would not be directly viewing physical objects in the environment, such as table 1229, and would instead be presented with a virtual reconstruction of the table 1229 produced from one or more sensors of the MR device (e.g., an outward facing camera capable of recording the surrounding environment).

The user 1202 can use any of the wrist-wearable device 1226, the AR device 1228 (e.g., through physical inputs at the AR device and/or built-in motion tracking of a user’s extremities), a smart-textile garment, externally mounted extremity tracking device, the HIPD 1242 to provide user inputs, etc. For example, the user 1202 can perform one or more hand gestures that are detected by the wrist-wearable device 1226 (e.g., using one or more EMG sensors and/or IMUs built into the wrist-wearable device) and/or AR device 1228 (e.g., using one or more image sensors or cameras) to provide a user input. Alternatively, or additionally, the user 1202 can provide a user input via one or more touch surfaces of the wrist-wearable device 1226, the AR device 1228, and/or the HIPD 1242, and/or voice commands captured by a microphone of the wrist-wearable device 1226, the AR device 1228, and/or the HIPD 1242. The wrist-wearable device 1226, the AR device 1228, and/or the HIPD 1242 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1228 (e.g., via an input at a temple arm of the AR device 1228). In some embodiments, the user 1202 can provide a user input via one or more facial gestures and/or facial expressions. For example, cameras of the wrist-wearable device 1226, the AR device 1228, and/or the HIPD 1242 can track the user 1202’s eyes for navigating a user interface.

The wrist-wearable device 1226, the AR device 1228, and/or the HIPD 1242 can operate alone or in conjunction to allow the user 1202 to interact with the AR environment. In some embodiments, the HIPD 1242 is configured to operate as a central hub or control center for the wrist-wearable device 1226, the AR device 1228, and/or another communicatively coupled device. For example, the user 1202 can provide an input to interact with the AR environment at any of the wrist-wearable device 1226, the AR device 1228, and/or the HIPD 1242, and the HIPD 1242 can identify one or more back-end and front-end tasks to cause the performance of the requested interaction and distribute instructions to cause the performance of the one or more back-end and front-end tasks at the wrist-wearable device 1226, the AR device 1228, and/or the HIPD 1242. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1242 can perform the back-end tasks and provide the wrist-wearable device 1226 and/or the AR device 1228 operational data corresponding to the performed back-end tasks such that the wrist-wearable device 1226 and/or the AR device 1228 can perform the front-end tasks. In this way, the HIPD 1242, which has more computational resources and greater thermal headroom than the wrist-wearable device 1226 and/or the AR device 1228, performs computationally intensive tasks and reduces the computer resource utilization and/or power usage of the wrist-wearable device 1226 and/or the AR device 1228.

In the example shown by the first AR system 1200a, the HIPD 1242 identifies one or more back-end tasks and front-end tasks associated with a user request to initiate an AR video call with one or more other users (represented by the avatar 1204 and the digital representation of the contact 1206) and distributes instructions to cause the performance of the one or more back-end tasks and front-end tasks. In particular, the HIPD 1242 performs back-end tasks for processing and/or rendering image data (and other data) associated with the AR video call and provides operational data associated with the performed back-end tasks to the AR device 1228 such that the AR device 1228 performs front-end tasks for presenting the AR video call (e.g., presenting the avatar 1204 and the digital representation of the contact 1206).

In some embodiments, the HIPD 1242 can operate as a focal or anchor point for causing the presentation of information. This allows the user 1202 to be generally aware of where information is presented. For example, as shown in the first AR system 1200a, the avatar 1204 and the digital representation of the contact 1206 are presented above the HIPD 1242. In particular, the HIPD 1242 and the AR device 1228 operate in conjunction to determine a location for presenting the avatar 1204 and the digital representation of the contact 1206. In some embodiments, information can be presented within a predetermined distance from the HIPD 1242 (e.g., within five meters). For example, as shown in the first AR system 1200a, virtual object 1208 is presented on the desk some distance from the HIPD 1242. Similar to the above example, the HIPD 1242 and the AR device 1228 can operate in conjunction to determine a location for presenting the virtual object 1208. Alternatively, in some embodiments, presentation of information is not bound by the HIPD 1242. More specifically, the avatar 1204, the digital representation of the contact 1206, and the virtual object 1208 do not have to be presented within a predetermined distance of the HIPD 1242. While an AR device 1228 is described working with an HIPD, an MR headset can be interacted with in the same way as the AR device 1228.

User inputs provided at the wrist-wearable device 1226, the AR device 1228, and/or the HIPD 1242 are coordinated such that the user can use any device to initiate, continue, and/or complete an operation. For example, the user 1202 can provide a user input to the AR device 1228 to cause the AR device 1228 to present the virtual object 1208 and, while the virtual object 1208 is presented by the AR device 1228, the user 1202 can provide one or more hand gestures via the wrist-wearable device 1226 to interact and/or manipulate the virtual object 1208. While an AR device 1228 is described working with a wrist-wearable device 1226, an MR headset can be interacted with in the same way as the AR device 1228.

### Integration of Artificial Intelligence with XR Systems

FIG. 12A illustrates an interaction in which an artificially intelligent virtual assistant can assist in requests made by a user 1202. The AI virtual assistant can be used to complete open-ended requests made through natural language inputs by a user 1202. For example, in FIG. 12A the user 1202 makes an audible request 1244 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 12A also illustrates an example neural network 1252 used in Artificial Intelligence applications. Uses of Artificial Intelligence (AI) are varied and encompass many different aspects of the devices and systems described herein. AI capabilities cover a diverse range of applications and deepen interactions between the user 1202 and user devices (e.g., the AR device 1228, an MR device 1232, the HIPD 1242, the wrist-wearable device 1226). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1202 can interact with an AI model through natural language inputs captured by a voice sensor, text inputs, or any other input modality that accepts natural language and/or a corresponding voice sensor module. In another instance, input is provided by tracking the eye gaze of a user 1202 via a gaze tracker module. Additionally, the AI model can also receive inputs beyond those supplied by a user 1202. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 1228) or from multiple devices that are in communication with each other (e.g., a system that includes at least two of an AR device 1228, an MR device 1232, the HIPD 1242, the wrist-wearable device 1226, etc.). The AI model can also access additional information (e.g., one or more servers 1230, the computers 1240, the mobile devices 1250, and/or other electronic devices) via a network 1225.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1228, an MR device 1232, the HIPD 1242, the wrist-wearable device 1226) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1228, an MR device 1232, the HIPD 1242, the wrist-wearable device 1226), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1242), haptic feedback can provide information to the user 1202. An AI model can also use the inputs described above to determine the appropriate modality and device(s) to present content to the user (e.g., a user walking on a busy road can be presented with an audio output instead of a visual output to avoid distracting the user 1202).

### Example Augmented Reality Interaction

FIG. 12B shows the user 1202 wearing the wrist-wearable device 1226 and the AR device 1228 and holding the HIPD 1242. In the second AR system 1200b, the wrist-wearable device 1226, the AR device 1228, and/or the HIPD 1242 are used to receive and/or provide one or more messages to a contact of the user 1202. In particular, the wrist-wearable device 1226, the AR device 1228, and/or the HIPD 1242 detect and coordinate one or more user inputs to initiate a messaging application and prepare a response to a received message via the messaging application.

In some embodiments, the user 1202 initiates, via a user input, an application on the wrist-wearable device 1226, the AR device 1228, and/or the HIPD 1242 that causes the application to initiate on at least one device. For example, in the second AR system 1200b the user 1202 performs a hand gesture associated with a command for initiating a messaging application (represented by messaging user interface 1212); the wrist-wearable device 1226 detects the hand gesture; and, based on a determination that the user 1202 is wearing the AR device 1228, causes the AR device 1228 to present a messaging user interface 1212 of the messaging application. The AR device 1228 can present the messaging user interface 1212 to the user 1202 via its display (e.g., as shown by user 1202’s field of view 1210). In some embodiments, the application is initiated and can be run on the device (e.g., the wrist-wearable device 1226, the AR device 1228, and/or the HIPD 1242) that detects the user input to initiate the application, and the device provides another device operational data to cause the presentation of the messaging application. For example, the wrist-wearable device 1226 can detect the user input to initiate a messaging application, initiate and run the messaging application, and provide operational data to the AR device 1228 and/or the HIPD 1242 to cause presentation of the messaging application. Alternatively, the application can be initiated and run at a device other than the device that detected the user input. For example, the wrist-wearable device 1226 can detect the hand gesture associated with initiating the messaging application and cause the HIPD 1242 to run the messaging application and coordinate the presentation of the messaging application.

Further, the user 1202 can provide a user input provided at the wrist-wearable device 1226, the AR device 1228, and/or the HIPD 1242 to continue and/or complete an operation initiated at another device. For example, after initiating the messaging application via the wrist-wearable device 1226 and while the AR device 1228 presents the messaging user interface 1212, the user 1202 can provide an input at the HIPD 1242 to prepare a response (e.g., shown by the swipe gesture performed on the HIPD 1242). The user 1202’s gestures performed on the HIPD 1242 can be provided and/or displayed on another device. For example, the user 1202’s swipe gestures performed on the HIPD 1242 are displayed on a virtual keyboard of the messaging user interface 1212 displayed by the AR device 1228.

In some embodiments, the wrist-wearable device 1226, the AR device 1228, the HIPD 1242, and/or other communicatively coupled devices can present one or more notifications to the user 1202. The notification can be an indication of a new message, an incoming call, an application update, a status update, etc. The user 1202 can select the notification via the wrist-wearable device 1226, the AR device 1228, or the HIPD 1242 and cause presentation of an application or operation associated with the notification on at least one device. For example, the user 1202 can receive a notification that a message was received at the wrist-wearable device 1226, the AR device 1228, the HIPD 1242, and/or other communicatively coupled device and provide a user input at the wrist-wearable device 1226, the AR device 1228, and/or the HIPD 1242 to review the notification, and the device detecting the user input can cause an application associated with the notification to be initiated and/or presented at the wrist-wearable device 1226, the AR device 1228, and/or the HIPD 1242.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1228 can present to the user 1202 game application data and the HIPD 1242 can use a controller to provide inputs to the game. Similarly, the user 1202 can use the wrist-wearable device 1226 to initiate a camera of the AR device 1228, and the user can use the wrist-wearable device 1226, the AR device 1228, and/or the HIPD 1242 to manipulate the image capture (e.g., zoom in or out, apply filters) and capture image data.

While an AR device 1228 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 12C-1 and 12C-2, the user 1202 is shown wearing the wrist-wearable device 1226 and an MR device 1232 (e.g., a device capable of providing either an entirely VR experience or an MR experience that displays object(s) from a physical environment at a display of the device) and holding the HIPD 1242. In the third AR system 1200c, the wrist-wearable device 1226, the MR device 1232, and/or the HIPD 1242 are used to interact within an MR environment, such as a VR game or other MR/VR application. While the MR device 1232 presents a representation of a VR game (e.g., first MR game environment 1220) to the user 1202, the wrist-wearable device 1226, the MR device 1232, and/or the HIPD 1242 detect and coordinate one or more user inputs to allow the user 1202 to interact with the VR game.

In some embodiments, the user 1202 can provide a user input via the wrist-wearable device 1226, the MR device 1232, and/or the HIPD 1242 that causes an action in a corresponding MR environment. For example, the user 1202 in the third MR system 1200c (shown in FIG. 12C-1) raises the HIPD 1242 to prepare for a swing in the first MR game environment 1220. The MR device 1232, responsive to the user 1202 raising the HIPD 1242, causes the MR representation of the user 1222 to perform a similar action (e.g., raise a virtual object, such as a virtual sword 1224). In some embodiments, each device uses respective sensor data and/or image data to detect the user input and provide an accurate representation of the user 1202’s motion. For example, image sensors (e.g., SLAM cameras or other cameras) of the HIPD 1242 can be used to detect a position of the HIPD 1242 relative to the user 1202’s body such that the virtual object can be positioned appropriately within the first MR game environment 1220; sensor data from the wrist-wearable device 1226 can be used to detect a velocity at which the user 1202 raises the HIPD 1242 such that the MR representation of the user 1222 and the virtual sword 1224 are synchronized with the user 1202’s movements; and image sensors of the MR device 1232 can be used to represent the user 1202’s body, boundary conditions, or real-world objects within the first MR game environment 1220.

In FIG. 12C-2, the user 1202 performs a downward swing while holding the HIPD 1242. The user 1202’s downward swing is detected by the wrist-wearable device 1226, the MR device 1232, and/or the HIPD 1242 and a corresponding action is performed in the first MR game environment 1220. In some embodiments, the data captured by each device is used to improve the user’s experience within the MR environment. For example, sensor data of the wrist-wearable device 1226 can be used to determine a speed and/or force at which the downward swing is performed and image sensors of the HIPD 1242 and/or the MR device 1232 can be used to determine a location of the swing and how it should be represented in the first MR game environment 1220, which, in turn, can be used as inputs for the MR environment (e.g., game mechanics, which can use detected speed, force, locations, and/or aspects of the user 1202’s actions to classify a user’s inputs (e.g., user performs a light strike, hard strike, critical strike, glancing strike, miss) or calculate an output (e.g., amount of damage)).

FIG. 12C-2 further illustrates that a portion of the physical environment is reconstructed and displayed at a display of the MR device 1232 while the MR game environment 1220 is being displayed. In this instance, a reconstruction of the physical environment 1246 is displayed in place of a portion of the MR game environment 1220 when object(s) in the physical environment are potentially in the path of the user (e.g., a collision with the user and an object in the physical environment are likely). Thus, this example MR game environment 1220 includes (i) an immersive VR portion 1248 (e.g., an environment that does not have a corollary counterpart in a nearby physical environment) and (ii) a reconstruction of the physical environment 1246 (e.g., table 1250 and cup 1252). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1226, the MR device 1232, and/or the HIPD 1242 are described as detecting user inputs, in some embodiments, user inputs are detected at a single device (with the single device being responsible for distributing signals to the other devices for performing the user input). For example, the HIPD 1242 can operate an application for generating the first MR game environment 1220 and provide the MR device 1232 with corresponding data for causing the presentation of the first MR game environment 1220, as well as detect the user 1202’s movements (while holding the HIPD 1242) to cause the performance of corresponding actions within the first MR game environment 1220. Additionally or alternatively, in some embodiments, operational data (e.g., sensor data, image data, application data, device data, and/or other data) of one or more devices is provided to a single device (e.g., the HIPD 1242) to process the operational data and cause respective devices to perform an action associated with processed operational data.

In some embodiments, the user 1202 can wear a wrist-wearable device 1226, wear an MR device 1232, wear smart textile-based garments 1238 (e.g., wearable haptic gloves), and/or hold an HIPD 1242 device. In this embodiment, the wrist-wearable device 1226, the MR device 1232, and/or the smart textile-based garments 1238 are used to interact within an MR environment (e.g., any AR or MR system described above in reference to FIGS. 12A–12B). While the MR device 1232 presents a representation of an MR game (e.g., second MR game environment 1220) to the user 1202, the wrist-wearable device 1226, the MR device 1232, and/or the smart textile-based garments 1238 detect and coordinate one or more user inputs to allow the user 1202 to interact with the MR environment.

In some embodiments, the user 1202 can provide a user input via the wrist-wearable device 1226, an HIPD 1242, the MR device 1232, and/or the smart textile-based garments 1238 that causes an action in a corresponding MR environment. In some embodiments, each device uses respective sensor data and/or image data to detect the user input and provide an accurate representation of the user 1202’s motion. While four different input devices are shown (e.g., a wrist-wearable device 1226, an MR device 1232, an HIPD 1242, and a smart textile-based garment 1238) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1238) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 1238 can be used in conjunction with an MR device and/or an HIPD 1242.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 12A–12C-2 provided above are intended to augment the description provided in reference to FIGS. 1-11. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A pair of smart glasses, comprising:
a temple arm;
a battery disposed within the temple arm, the battery comprising a polymerized electrolyte; and
a hermetic coating enclosing the battery and coupled to the temple arm, wherein a portion of the polymerized electrolyte is bonded to the hermetic coating.

2. The smart glasses of claim 1, wherein:
the battery is mechanically coupled to the temple arm such that mechanical forces applied to the temple arm are at least partially supported by the battery; and
the battery is configured to withstand cyclic deformation without degradation of battery performance.

3. The smart glasses of claim 1, wherein:
the battery comprises an electrode stack having a first layer and a second layer; and
the first layer of the electrode stack has a different geometry than the second layer of the electrode stack.

4. The smart glasses of claim 3, wherein:
the electrode stack is a non-cuboidal shape; and
the electrode stack conforms to a curved geometry of the temple arm.

5. The smart glasses of claim 1, wherein the hermetic coating further comprises:
a substrate layer disposed between the battery and a flexible layer;
the flexible layer disposed on the substrate layer, wherein the flexible layer is configured to enable the hermetic coating to tolerate cyclic deformation;
the hermetic coating disposed on the flexible layer, wherein the hermetic coating forms a seal around the battery that prevents moisture ingress into the battery; and
a protective layer disposed on the hermetic coating, wherein the protective layer is configured to at least partially seal the hermetic coating from environmental exposure.

6. The smart glasses of claim 1, further comprising:
an inner cover disposed within the temple arm and coupled to the battery, wherein:
at least a portion of the inner cover is coated in the hermetic coating; and
the polymerized electrolyte is bonded to at least the portion of the hermetic coating of the inner cover;
an electrical component; and
an outer cover configured to at least partially seal the temple arm, wherein the outer cover encloses an electrical component and the inner cover within the temple arm.

7. The smart glasses of claim 1, wherein the temple arm includes:
a front portion of the temple arm;
a rear portion of the temple arm; and
a connector configured to removably couple the front portion of the temple arm and the rear portion of the temple arm; and
the smart glasses further comprising:
a lens frame; and
a hinge coupled to the lens frame and the front portion of the temple arm.

8. The smart glasses of claim 1, further comprising:
a lens frame; and
a hinge including a first hinge component and a second hinge component;
the first hinge component coupled to the lens frame, wherein the first hinge component includes a first connector; and
the second hinge component coupled to the temple arm, wherein the second hinge component includes a second connector configured to removably couple to the first connector of the first hinge component.

9. The smart glasses of claim 1, wherein the battery has a flexural rigidity between 2 Nm² and 10 Nm².

10. The smart glasses of claim 1, wherein the battery is configured to maintain at least 80% capacity retention after 11,000 bend cycles.

11. The smart glasses of claim 1, wherein the electrolyte comprises a polymer electrolyte having a tunable elastic modulus.

12. A structural battery for a wearable device, comprising:
an electrode stack comprising a plurality of alternating anode layers and cathode layers;
a polymer electrolyte disposed between the plurality of alternating anode layers and cathode layers, wherein the polymer electrolyte provides mechanical support to the electrode stack; and
a hermetic coating disposed around the electrode stack and the polymer electrolyte, wherein the polymer electrolyte is bonded to the hermetic coating.

13. The structural battery of claim 12, wherein:
the electrode stack has a first layer and a second layer; and
the first layer of the electrode stack has a different geometry than the second layer of the electrode stack.

14. The structural battery of claim 12, wherein the hermetic coating comprises:
a hermetic layer encapsulating the electrode stack to prevent moisture ingress into the electrode stack and the polymer electrolyte;
a flexible layer disposed on a first side of the hermetic layer to support the hermetic coating during cyclic deformation; and
a protective layer disposed on a second side of the hermetic layer, opposite the first side, that at least partially seals the hermetic layer from environmental exposure.

15. The structural battery of claim 12, wherein the polymer electrolyte has a tunable elastic modulus configured to provide a selected flexural rigidity for the structural battery.

16. The structural battery of claim 12, wherein the hermetic coating includes a port configured to enable injection of the polymer electrolyte into the electrode stack, wherein the port is sealed after injection of the polymer electrolyte.

17. The structural battery of claim 12, wherein:
the structural battery has a flexural rigidity between 2 Nm² and 10 Nm²; and
the battery is configured to maintain at least 80% capacity retention after 11,000 bend cycles.

18. A method of manufacturing a wearable device with an integrated structural battery, comprising:
applying a hermetic coating to an interior surface of a housing of the wearable device;
applying the hermetic coating to an interior surface of an inner cover of the wearable device;
disposing an electrode stack within the housing such that the electrode stack is adjacent to the hermetic coating of the housing;
sealing the electrode stack within the housing with the inner cover such that the electrode stack is adjacent to the hermetic coating of the inner cover;
injecting a polymer electrolyte into the housing such that the polymer electrolyte contacts the hermetic coating and is disposed between electrode layers of the electrode stack; and
curing the polymer electrolyte to bond the polymer electrolyte to the hermetic coating and to the electrode layers of the electrode stack.

19. The method of claim 18, further comprising:
disposing an electrical component over the inner cover; and
sealing the housing with an outer cover, wherein the outer cover encloses the electrical component, the inner cover, and the electrode stack within the housing.

20. The method of claim 18, further comprising overmolding the housing with a thermoplastic such that the housing is encapsulated by the thermoplastic.
